(19) United States
(12) Patent Application Publication
(10) Pub. No.: US 2024/0389715 A1
(43) Pub. Date: Nov. 28, 2024

(54) SYSTEMS AND METHODS OF FORMING ARTICLES OF FOOTWEAR USING A BASE FOOTWEAR STRUCTURE

(71) Applicant: NIKE, Inc., Beaverton, OR (US)

(72) Inventors: Michael Jones, Beaverton, OR (US); Thea Moshofsky, Beaverton, OR (US); Yong S. Lee, Portland, OR (US); Randall S. Wolfe, Beaverton, OR (US); David Ngene, Hillsboro, OR (US)

(73) Assignee: NIKE, Inc., Beaverton, OR (US)

(21) Appl. No.: 18/788,537

(22) Filed: Jul. 30, 2024

Related U.S. Application Data
(63) Continuation of application No. 17/213,691, filed on Mar. 26, 2021, now abandoned.
(60) Provisional application No. 63/005,042, filed on Apr. 3, 2020.

(51) Int. Cl. A43B 23/02; A43B 3/00

(52) U.S. Cl. CPC A43B 23/025; A43B 3/0078

(57) ABSTRACT

A non-transient computer-readable medium can contain instructions for causing a computing system to perform the method of selecting a base footwear structure, the base footwear structure including an upper that is configured to be coupled to a sole structure, retrieving a model of an article of footwear that can be formed from the selected base footwear structure, selecting one or more design elements from a plurality of available design elements associated with the model, updating the model based on the one or more selected design elements, and generating the article of footwear from the updated model. In some examples, the one or more design elements are design elements that can be added to or modified on the base footwear structure to form the article of footwear.

### CROSS REFERENCE TO RELATED APPLICATION

This application is a continuation of U.S. patent application Ser. No. 17/213,691, filed Mar. 26, 2021, which claims the benefit of U.S. Provisional Patent Application No. 63/005,042, filed Apr. 3, 2020, which is incorporated herein by reference in its entirety.

### FIELD

This disclosure relates generally to articles of footwear and, in particular, systems and methods of forming multiple, distinct articles of footwear using a base footwear structure.

### BACKGROUND

An article of footwear typically includes two main components: a sole structure and an upper. The sole structure is configured for supporting the wearer's foot and providing cushioning between the wearer's foot and the ground. The sole structure may include an outsole that is adapted to contact the ground. The upper is coupled to the sole structure and is configured for securing the wearer's foot to the sole structure. The upper can include different design elements, including various colors, stitching, overlays, graphics, and the like.

### BRIEF DESCRIPTION OF THE DRAWINGS

FIG. 1 is a schematic illustration showing an exemplary method of forming multiple, distinct articles of footwear from a same base footwear structure.

FIG. 2 is a flow chart of an exemplary method for forming an article of footwear using a base footwear structure.

FIG. 3 is a flow chart of an exemplary method for individually selecting design elements from a model of an article of footwear that can be formed from a base footwear structure.

FIG. 4 is an exemplary table of a plurality of different footwear design models, each including a plurality of predetermined design elements, that can be stored within a model of an article of footwear that can be formed from a base footwear structure.

FIG. 5 is an exemplary table of a plurality of design element options for a plurality of base design elements of a base footwear structure that can be stored in a model of an article of footwear that can be formed from the base footwear structure.

FIG. 6 is an exemplary table of a plurality of design element options for a plurality of additional design elements that can be added to a base footwear structure that can be stored in a model of an article of footwear that can be formed from the base footwear structure.

FIG. 7 is an exemplary table of a plurality of design element options for a selected design element to be added to a base footwear structure that can be stored in a model of an article of footwear that can be formed from the base footwear structure.

FIGS. 8A-8B illustrate an embodiment of a base footwear structure comprising an upper, sole structure, and tongue.

FIGS. 9A-14B illustrate exemplary, distinct articles of footwear that can be formed by customizing and/or selecting design elements of a model of an article of footwear that can be formed from the base footwear structure of FIGS. 8A-8B.

FIG. 15 illustrates another embodiment of a base footwear structure and exemplary, distinct articles of footwear that can be formed by customizing and/or selecting design elements of a model of an article of footwear that can be formed from the base footwear structure.

FIG. 16 is a schematic illustration showing an exemplary method of forming a base footwear structure from a plurality of distinct articles of footwear.

FIG. 17 is a flow chart of an exemplary method for forming a base footwear structure for an article of footwear.

FIG. 18 illustrates an exemplary computing system for implementing the disclosed methods.

### DETAILED DESCRIPTION

### General Considerations

The systems and methods described herein, and individual components thereof, should not be construed as being limited to the particular uses or systems described herein in any way. Instead, this disclosure is directed toward all novel and non-obvious features and aspects of the various disclosed embodiments, alone and in various combinations and subcombinations with one another. For example, any features or aspects of the disclosed embodiments can be used in various combinations and subcombinations with one another, as will be recognized by an ordinarily skilled artisan in the relevant field(s) in view of the information disclosed herein. In addition, the disclosed systems, methods, and components thereof are not limited to any specific aspect or feature or combinations thereof, nor do the disclosed things and methods require that any one or more specific advantages be present or problems be solved.

As used in this application the singular forms “a,” “an,” and “the” include the plural forms unless the context clearly dictates otherwise. Additionally, the term “includes” means “comprises.” Further, the term “coupled” or “secured” encompasses mechanical and chemical couplings, as well as other practical ways of coupling or linking items together, and does not exclude the presence of intermediate elements between the coupled items unless otherwise indicated, such as by referring to elements, or surfaces thereof, being “directly” coupled or secured. Furthermore, as used herein, the term “and/or” means any one item or combination of items in the phrase.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “provide,” “produce,” “determine,” and “select” to describe the disclosed methods. These terms are high-level descriptions of the actual operations that are performed. The actual operations that correspond to these terms will vary depending on the particular implementation and are readily discernible by one of ordinary skill in the art having the benefit of this disclosure.

For purposes of this disclosure, portions of an article of footwear (and the various component parts thereof) may be identified based on regions of the foot located at or near that portion of the article of footwear when the footwear is worn on the properly sized foot. For example, an article of footwear and/or a sole structure may be considered as having a “forefoot region” at the front of the foot, a “midfoot” region at the middle or arch area of the foot, and a “heel region” at the rear of the foot. Footwear and/or sole structures also include a “lateral side” (the “outside” or “little toe side” of the foot) and a “medial side” (the “inside” or “big toe side” of the foot). The forefoot region generally includes portions of the footwear corresponding to the toes and the joints connecting the metatarsals with the phalanges. The midfoot region generally includes portions of the footwear corresponding with the arch area of the foot. The heel region generally corresponds with the rear portions of the foot, including the calcaneus bone. The lateral and medial sides of the footwear extend through the forefoot, midfoot, and heel regions and generally correspond with opposite sides of the footwear (and may be considered as being separated by a central longitudinal axis). These regions and sides are not intended to demarcate precise areas of footwear. Rather, the terms “forefoot region,” “midfoot region,” “heel region,” “lateral side,” and “medial side” are intended to represent general areas of an article of footwear and the various components thereof to aid the in discussion that follows.

As used herein, the term “exemplary” means serving as a non-limiting example, instance, or illustration. As used herein, the terms “e.g.,” and “for example,” introduce a list of one or more non-limiting embodiments, examples, instances, and/or illustrations.

As used herein, the term “sole structure” refers to any combination of materials that provides support for a wearer's foot and bears the surface that is in direct contact with the ground or playing surface, such as, for example, a single sole; a combination of an outsole and an inner sole; a combination of an outsole, a midsole, and an inner sole; and a combination of an outer covering, an outsole, a midsole and an inner sole.

As used herein, the terms “attached” and “coupled” generally mean physically connected or linked, which includes items that are directly attached/coupled and items that are attached/coupled with intermediate elements between the attached/coupled items, unless specifically stated to the contrary.

As used herein, the terms “articles of footwear” or “articles” mean any type of footwear, including, for example, basketball shoes, volleyball shoes, tennis shoes, running shoes, soccer shoes, football shoes, rugby shoes, baseball shoes, sneakers, hiking boots, sandals, socks, etc.

Although the figures may illustrate an article of footwear intended for use on only one foot (e.g., a right foot) of a wearer. One skilled in the art and having the benefit of this disclosure will recognize that a corresponding article of footwear for the other foot (e.g., a left foot) would be a mirror image of the right article of footwear.

As used herein, the term “design element” refers to a component or element of an article of footwear that may be visualized and used to distinguish the article of footwear from another article of footwear having a different design element. Design elements can include features of an element or component of an article of footwear (e.g., a color, material, pattern, shape, or the like, of an upper, outsole, midsole, overlay, and the like) and/or an element that can be added to a base structure of the article of footwear (e.g., an overlay, stitching detail, tape element, or the like).

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features of the disclosure are apparent from the detailed description, claims, abstract, and drawings.

### The Disclosed Technology

An article of footwear typically includes two main components: a sole structure and an upper. The sole structure is configured for supporting the wearer's foot and providing cushioning between the wearer's foot and the ground. The upper is coupled to the sole structure and forms a foot-receiving cavity. The upper is configured for securing the wearer's foot to the sole structure and/or can protect the wearer's foot.

The upper can include different design elements, including various materials, stitching details, overlays, graphics, and the like. In some embodiments, the materials of the upper can have different colors and/or patterns. Further, components or design elements included on the upper, such as overlays, can comprise different materials, colors, patterns, shapes, sizes, and be placed in different locations on the upper (e.g., the heel region, lateral/medial sides, vamp, toe region, and the like). Additionally, the sole structure can also have various design elements, such as different colors, materials, and/or styles (e.g., shape, size, patterning, or the like).

Thus, numerous different combinations of design elements for an article of footwear are possible and can be used to form numerous, distinct (e.g., visually distinct) articles of footwear. Because of the complexity of articles of footwear, including the construction of individual components and the assembly of such components into an article of footwear, it can take significant time and effort to develop a new article of footwear having new or updated design elements.

Disclosed herein are various methods of forming an article of footwear using a base footwear structure, a footwear line including a plurality of articles of footwear that are distinct from one another but have a same base footwear structure, and various methods for forming a base footwear structure for an article of footwear.

In one representative embodiment, a method is provided for forming an article of footwear. The method includes selecting a base footwear structure, the base footwear structure comprising an upper that is configured to be coupled to a sole structure, retrieving a model of an article of footwear that can be formed from the selected base footwear structure, selecting one or more design elements from a list of available design elements associated with the model, updating the model based on the one or more selected design elements, and generating the article of footwear from the updated model. The one or more design elements are design elements that can be added to or modified on the base footwear structure to form the article of footwear.

In another representative embodiment a method is provided for forming an article of footwear. The method includes selecting a base footwear structure, retrieving a model of an article of footwear that can be formed from the selected base footwear structure, selecting one or more modifiable design elements from a first list of available modifiable design elements associated with the model, selecting one or more add-on design elements from a list of available add-on design elements stored in the model, updating the model based on the one or more selected modifiable design elements and the one or more selected add-on design elements, and generating the article of footwear from the updated model. The base footwear structure can include a sole structure and an upper, the upper coupled to the sole structure. The one or more modifiable design elements can be design elements that can be updated on the base footwear structure to form the article of footwear. The one or more add-on design elements can be design elements that can be added to the base footwear structure to form the article of footwear.

In yet another representative embodiment, a footwear line is provided. The footwear line includes a plurality of articles of footwear that are each distinct from one another, all having a same base footwear structure, the base footwear structure comprising at least an upper configured to be coupled to a sole structure. Each article of footwear of the plurality of articles of footwear includes a different design element added to the base footwear structure such that each article of footwear of the plurality of articles of footwear is visually distinct.

In still another representative embodiment, a method is provided for forming a base footwear structure for an article of footwear. The method includes obtaining a plurality of structural and design elements from two or more different articles of footwear that are visually distinct and determining the base footwear structure from the obtained plurality of structural and design elements. The base footwear structure comprises an upper configured to be coupled to a sole structure and is generic to the two or more different articles of footwear.

Additional examples of the disclosed technology are described below with reference to the accompanying drawings.

### Exemplary Embodiments of the Disclosed Technology

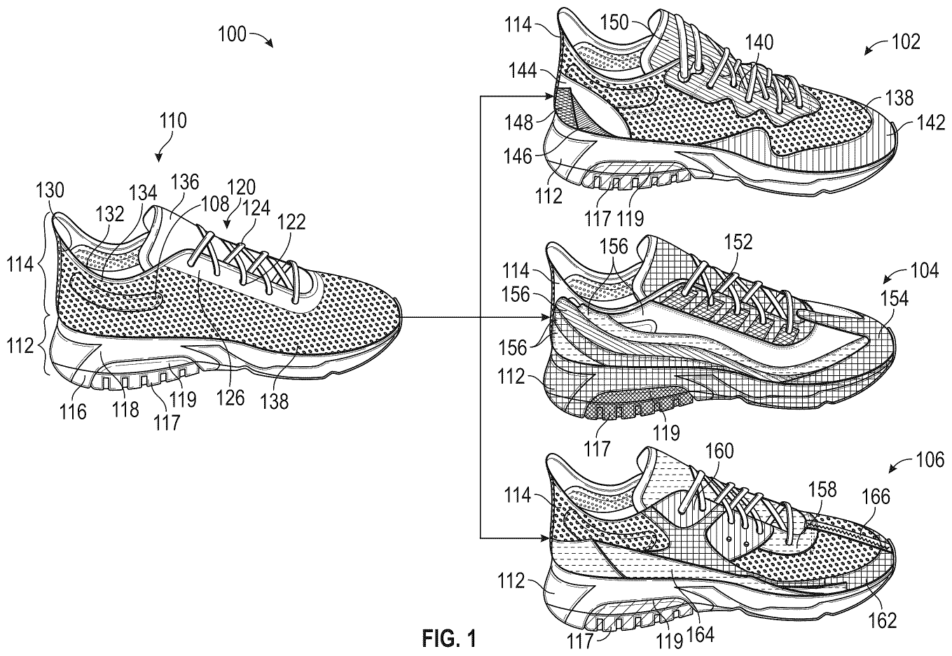

FIG. 1 is a schematic 100 illustrating how multiple, distinct articles of footwear can be formed from a same base footwear structure. Specifically, FIG. 1 shows three exemplary articles of footwear including a first article of footwear 102, a second article of footwear 104, and a third article of footwear 106, each formed from the same base footwear structure 110.

In general, an article of footwear includes two main components: a sole structure 112 and an upper 114 (as indicated on the base footwear structure 110 in FIG. 1). The sole structure 112 can include an outsole 116 and a midsole 118. The outsole 116 can be configured with one or more traction surfaces and/or can be configured to cover and/or protect at least a portion of the midsole 118 and/or the upper 114. The midsole 118 can be disposed between the upper 114 and the outsole 116 and can be configured to provide cushioning. In some embodiments, as shown in FIG. 1, the sole structure 112 can include one or more cushioning elements, such as a midsole cushioning element 119. Further, in some embodiments, the outsole 116 can comprise a semi-transparent portion 117 arranged adjacent to the midsole cushioning element 119.

The upper 114 can be coupled to the midsole (e.g., via a strobel) so as to form a foot-receiving cavity between the sole structure 112 and the upper 114. For example, the upper 114 may include one or more material elements (for example, textiles, foam, leather, and synthetic leather), which may be stitched, adhesively bonded, molded, or otherwise formed to define an interior void configured to receive a foot.

The upper 114 can include a closure element 130, which in some embodiments may be a line of stitches (e.g., stitching) that serves to close and connect together open ends of the upper 114 during manufacturing. As shown in FIG. 1, the closure element 130 can run along a heel portion (or region) of the upper 114, in a vertical direction.

The upper 114 can further include a topline 132, a collar finishing 134 (which may include a line of stitches), and a lacing region 120. The lacing region 120 includes apertures 122 (e.g., eyelets) for receiving a lace 124 that can be tightened to close the upper 114 around a foot. The lacing region 120 further includes an eyestay 126 that serves to anchor the apertures 122.

The upper 114 can also include an internal support structure (which may not be visible from the external view of FIG. 1) comprising one or more reinforcement elements and/or linings arranged at different locations of the upper 114, such as at a heel portion, a toe portion, medial and/or lateral side portions, or the like, of the upper 114. As one example, as shown in FIG. 1, the upper 114 can include a first reinforcement element 108 positioned on medial and lateral sides of the upper 114, proximate to the collar finishing 134 and the heel portion of the upper 114.

The article of footwear can further comprise a tongue 136, which in some embodiments can be considered part of the upper 114.

In some embodiments, the base footwear structure 110 may comprise both the upper 114 and the sole structure 112, as shown in FIG. 1.

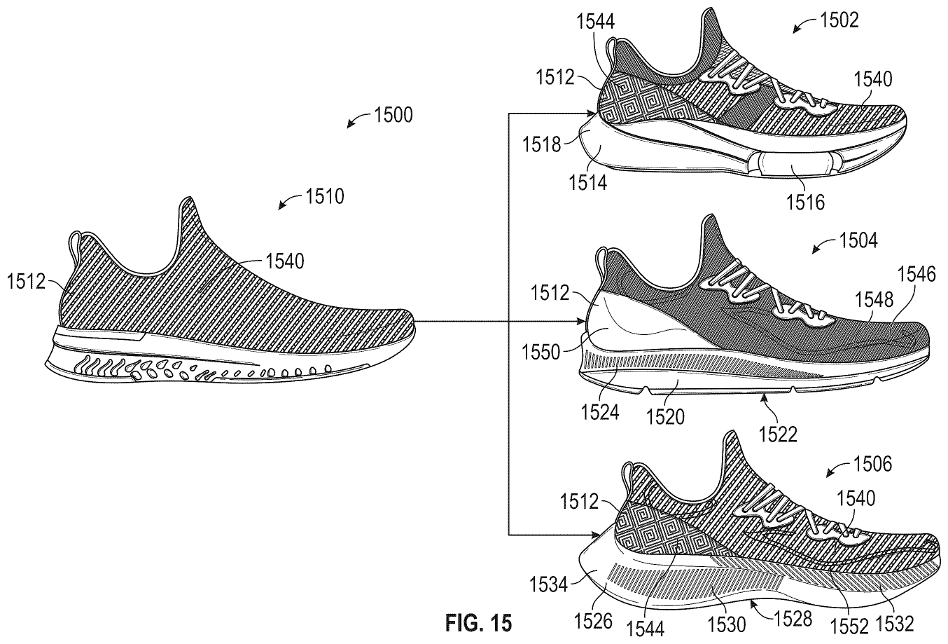

In other embodiments, the base footwear structure 110 may comprise only the upper 114 (and not the sole structure 112). However, the upper 114 of the base footwear structure 112 can be configured to be coupled to a sole structure, such as the sole structure 112 shown in FIG. 1. As described further below with reference to FIG. 15, when forming different articles of footwear from a base footwear structure comprising only the upper 114, different sole structures (e.g., sole structures having different sizes, shapes, styles, and/or components) may be selected from a model of an article of footwear that can be formed from the base footwear structure. Thus, a selected sole structure can be combined with the upper 114 of the base footwear structure 110 to form the desired article of footwear.

As shown in FIG. 1, the upper 114 of the base footwear structure 110 can comprise a base material 138, an internal support structure (including the first reinforcement elements 108 shown in FIG. 1), the closure element 130, the topline 132, the collar finishing 134, and the lacing region 120.

In other embodiments, the upper 114 of the base footwear structure 110 can comprise a subset of the elements shown in FIG. 1, such as the base material 138, the internal support structure (which may include one or more support and/or reinforcement elements), the closure element 130, and the topline 132. In still other embodiments, the upper 114 of the base footwear structure 110 may comprise different or additional base components or elements than those shown in FIG. 1 (e.g., additional or different stitching lines or details, internal or external support or reinforcement elements, laces, tongues, eyestays, straps, and/or the like).

In some embodiments, the base material 138 of the upper 114 can be a knit or mesh material (e.g., an engineered mesh material). In other embodiments, the base material 138 of the upper 114 of the base footwear structure 110 can comprise another material, such as leather or synthetic leather.

As seen in FIG. 1, the upper 114 of the base footwear structure 110 may be somewhat generic (e.g., simplified), comprising the base material (e.g., comprising a single material or minimal materials) 138 and neutral colors, for example. As described further below, in some embodiments, the base material 138 of the upper 114 (e.g., a color of the material of the upper) is a design element that may be changed (e.g., customized).

Each of the first article of footwear 102, the second article of footwear 104, and the third article of footwear 106 can be created from the base footwear structure 110 in FIG. 1, including the upper 114 and the sole structure 112, by modifying design elements of or adding design elements to the base footwear structure 110, thereby resulting in three distinct articles of footwear.

As used herein, a “design element” may be a component or element of an article of footwear that may be visualized and used to distinguish the article of footwear from another article of footwear having a different design element. Design elements can include features of an element or component of an article of footwear (e.g., a color, material, pattern, shape, or the like, of an upper, outsole, midsole, overlay, and the like) and/or an element that can be added to a base structure of the article of footwear (e.g., an overlay, stitching detail, tape element, or the like).

As shown in FIG. 1 and explained further below, the modified and/or additional design elements included on the different articles of footwear are represented by different cross-hatching. For example, varying colors and/or materials of the design elements may be represented by different cross-hatching in FIG. 1 and the other figures presented herein.

As an example, the first article of footwear 102 shown in FIG. 1 has the same overall sole structure 112 and upper 114 as the base footwear structure 110. However, in the first article of footwear 102, the midsole cushioning element 119 and the semi-transparent portion 117 of the outsole 116 are a different color than in the base footwear structure 110, as denoted by the different cross-hatching, while a remainder of the sole structure 112 (e.g., the structure, including the shape, size, and patterning) remains the same as in the base footwear structure 110.

The upper 114 of the first article of footwear 102 is made of the same base material 138 as the base footwear structure 110. However, additional design elements have been added to the base footwear structure 110 to result in the first article of footwear 102. As shown in the example of FIG. 1, these additional elements include an eyestay overlay 140, a toe cap overlay 142, a first heel overlay 144, a second heel overlay 146 (at least partially overlapping the first heel overlay 144), and a third heel overlay 148 (at least partially overlapping the second heel overlay 142). Further, the first article of footwear has a tongue 150 comprising a different material and/or color than the tongue 136 of the base footwear structure 110 (as denoted by the different cross-hatching).

The second article of footwear 104 is also created from the same upper 114 and sole structure 112 of the base footwear structure 110. However, the second article of footwear 104 is visually distinct from the first article of footwear 102.

For example, the base color of the midsole 118 and outsole 116 in the second article of footwear 104 has been modified from that of the base footwear structure 110 and is different than that of the first article of footwear 102 (e.g., black instead of white). Further, the second article of footwear 104 has a differently colored cushioning element 117 and semi-transparent portion 117 of the outsole 116.

The second article of footwear 104 also has a plurality of overlays added to the base material 138 of the upper 114 (e.g., stitched or adhered over top of the base material 138). For example, the upper 114 of the second article of footwear includes a differently designed (e.g., color, shape, and pattern) eyestay overlay 152, toe cap overlay 154, and series of overlapping medial/lateral side overlays 156. As an example, each of the series of overlapping medial/lateral side overlays 156 are different colors and comprise a different material than the base material 138 of the upper 114. The addition of these overlays and the color changes to the sole structure results in the second article of footwear 104 having a different visual style than the first article of footwear 102.

The third article of footwear 106 is also created from the same upper 114 and sole structure 112 of the base footwear structure 110, but has a different visual style and appearance when compared to the first article of footwear 102 and the second article of footwear 104. The design elements that are modified on the base footwear structure 110 to obtain the third article of footwear 106 include the color of the cushioning element 117 and the semi-transparent portion 117 of the outsole 116. The design elements added to the base footwear structure 110 to obtain the third article of footwear 106 include a first eyestay overlay 158, a second eyestay overlay 160, a toe cap and medial/lateral overlay 162, a medial/lateral side overlay 164, and a toe stitching element 166.

In this way, by changing the design elements of and/or adding design elements to the base footwear structure 110, a plurality of distinct (e.g., having visually different appearances) articles of footwear (such as the examples shown in FIG. 1) can be formed more efficiently. In particular, by using a common framework (base footwear structure), different articles of footwear can be created faster and with less effort. Thus, the base footwear structure serves as a base from which numerous different articles of footwear can be created, as explained further below.

While FIG. 1 shows examples of three possible articles of footwear that may be obtained from the same base footwear structure, it should be recognized that it is possible to construct numerous, additional articles of footwear having different combinations of different design elements than those shown in FIG. 1, from the same base footwear structure. Thus, different design element combinations not shown in FIG. 1 are possible using the same base footwear structure.

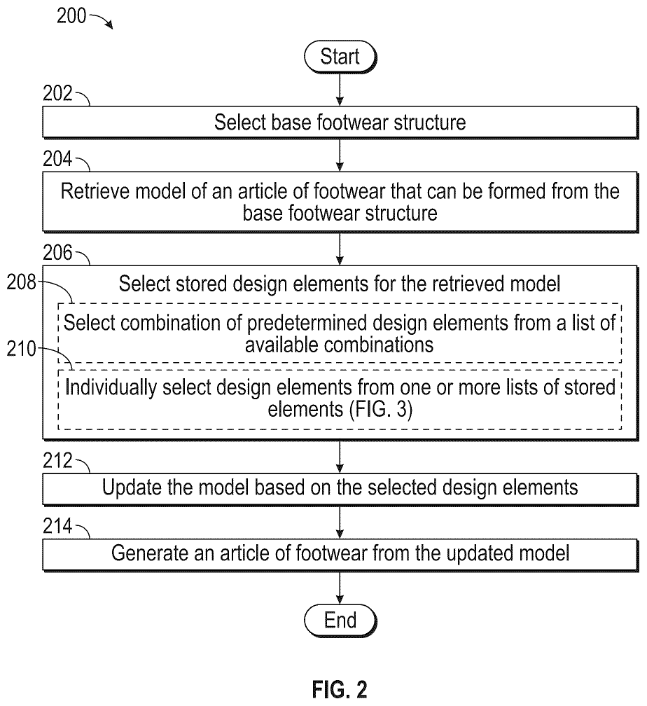

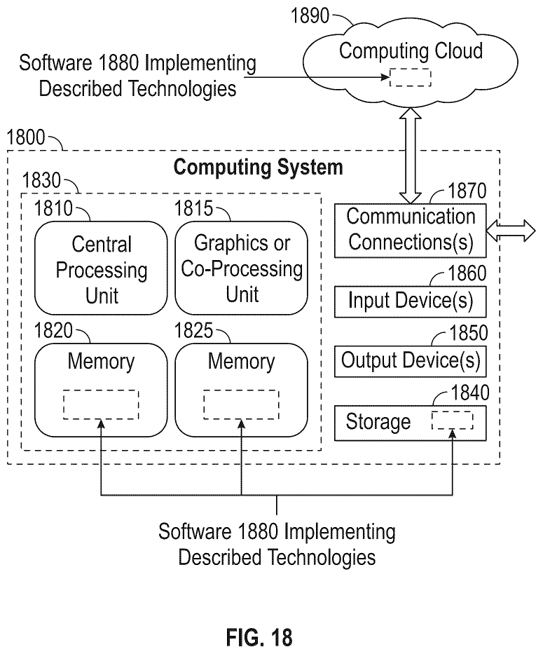

FIG. 2 is a flow chart of a method 200 for forming an article of footwear using a base footwear structure. In some embodiments, method 200 and the other methods described herein (e.g., methods 300 and 1700) may be at least partially performed by a computing system that is operable by a human user. An example of such a computing system is shown in FIG. 18 (e.g., computing system 1800), as described further below.

For example, in some embodiments the computing system may include suitable hardware systems for receiving and sending information and controlling one or more systems in electronic communication (e.g., wired or wireless communication) with the computing system (e.g., one or more printing systems or devices). For example, the computing system can include one or more computers, servers, processors, storage devices, user input devices (e.g., keyboard and mouse), viewing interfaces (e.g., a monitor or screen), and the like. However, in other embodiments, other forms of hardware systems may be used. The one or more storage devices can include, but are not limited to, magnetic, optical, magneto-optical, and/or memory, including volatile memory and non-volatile memory. In some embodiments, computer-executable instructions for executing at least a portion of method 200 and/or the other methods described herein may be stored in the one or more storage devices (e.g., memory and/or storage) and may be executed by one or more processors of the computing system. For example, the one or more processors may execute the instructions in conjunction with one or more user inputs, as described further below. In some embodiments, the computing system can also include software for designing a base footwear structure and a model of an article of footwear that can be formed from the base footwear structure (e.g., a computer-aided design representation of the article of footwear), as described further below with reference to FIGS. 2, 3, and 17.

Returning to FIG. 2, method 200 begins at 202 by selecting a base footwear structure. In some embodiments, the base footwear structure includes an upper that is configured to be coupled to a sole structure. In other embodiments, the base footwear structure includes the upper and a sole structure, the upper coupled to the sole structure. In some embodiments, the base footwear structure additionally includes a tongue configured to be coupled with the upper.

In some embodiments, the base footwear structure can comprise more basic materials and colors, such that a plurality of differently designed and visually distinct articles of footwear can be generated by starting from (and modifying or adding to, as described further below) the base footwear structure. For example, in some embodiments, the upper of the base footwear structure may be comprised of a one (e.g., a single) main material (e.g., a fabric such as a mesh material) and basic supporting (e.g., inner support structure) and stitching elements. As an example, the basic supporting and stitching elements can comprise one or more reinforcement elements and/or linings (e.g., an upper liner) and a closure element (at the heel, also referred to as a heel coverstitch). In some embodiments, the upper of the base footwear structure may further include a basic eyestay.

As another example, in some embodiments, the sole structure of the base footwear structure can comprise a midsole and outsole which can comprise a standard material and a more neutral color (e.g., white, off-white, grey, or the like).

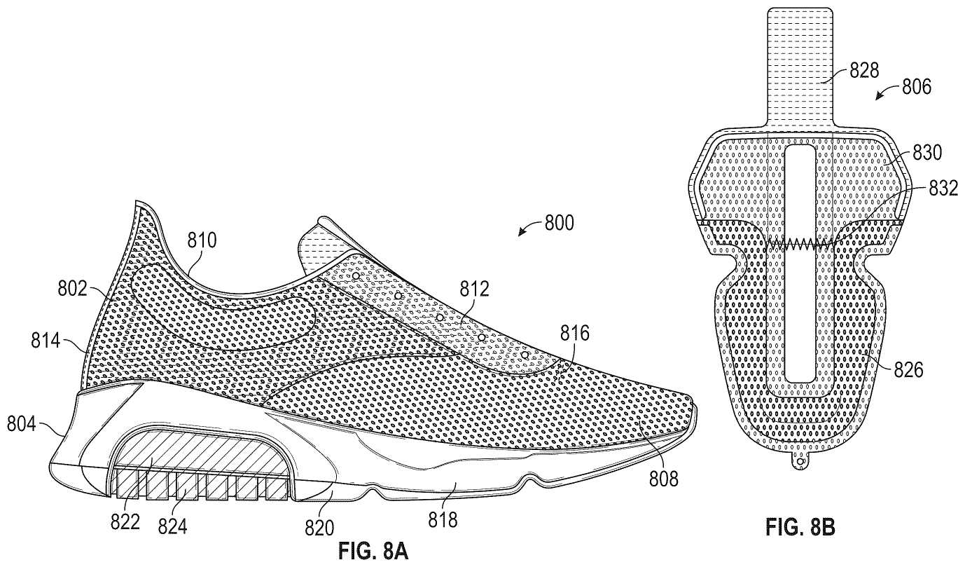

Example base footwear structures are shown in FIG. 1 (base footwear structure 110), FIGS. 8A-8B (base footwear structure 800), and FIG. 15 (base footwear structure 1510), as described further above and below.

In some embodiments, selecting the base footwear structure at 202 includes selecting one base footwear structure from a finite list of multiple, distinct base footwear structures. For example, two or more base footwear structures may be available for forming a desired article of footwear. Each base footwear structure of the list of multiple base footwear structures can include a differently structured or designed upper and/or a sole structure. As one example, each base footwear structure can have a differently structured upper from each other base footwear structure in the list of multiple base footwear structures. The differently structured upper may include a different overall shape of the upper, different numbers, combinations, or shapes of the internal support structure elements, different stitching elements, a different lacing region, and/or the like.

The components and design elements of the base footwear structure, as described above, can be stored in a model (e.g., computer model) of an article of footwear that can be formed from the base footwear structure. In some embodiments, the model can be stored in a storage device of a computing system and retrieved by a processor of the computing system, such as the computing system 1800 shown in FIG. 18, as described further below.

Thus, the method at 204 includes retrieving a model of an article of footwear that can be formed from the selected base footwear structure. In some embodiments, one or more models of an article of footwear can be stored in memory of the computing device, including one model corresponding to each base footwear structure. Thus, if more than one base footwear structure is available for selection, more than one model may be stored and selectable by a user. As an example, the model of the article of footwear can include computer aided design (CAD) data of an article of footwear that can be formed from the base footwear structure and a plurality of design element options that can be modified on or added to the base footwear structure. The plurality of design element options can be stored within the model and presented to a user for selection.

Continuing to 206, method 200 includes selecting one or more design elements from a list of available design elements stored in the model. As introduced above, the one or more design elements can be design elements that can be added to or updated on the base footwear structure to form the desired article of footwear.

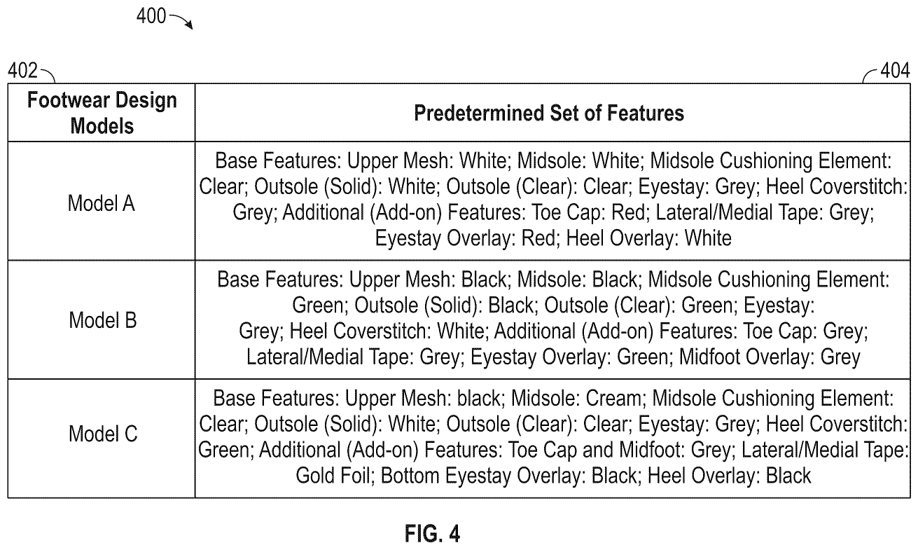

In some embodiments, the method at 206 may include, at 208, selecting a combination of predetermined design elements from a list of available combinations. For example, a plurality of different footwear design models can be stored as a list or table within the model of the article of footwear. Each footwear design model can include a combination of multiple, predetermined design elements that can be updated on and/or added to the base footwear structure. An example of such a table that may be part of or stored in the model of the article of footwear is shown in FIG. 4.

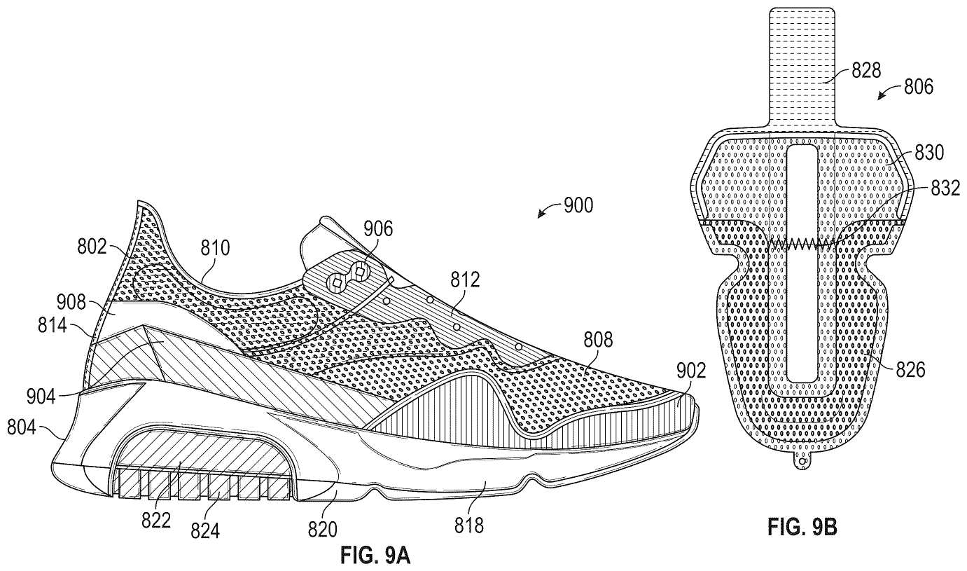

As shown in the exemplary table 400 in FIG. 4, the table 400 can include a plurality of footwear design models (column 402) which may be selected by a user. For example, a user may be presented with the plurality of footwear design models in the table, either visually (e.g., via an image of the resulting article of footwear that can be created from the selected footwear design model, such as one of the images shown in FIGS. 9A-14B, for example) or via a list or drop-down menu listing the plurality of footwear design models.

Each available footwear design model can include a plurality of predetermined design elements that will be combined together, using the base footwear structure, to create the article of footwear. An example of such predetermined design elements for each footwear design model is shown in column 404 of table 400. As an example, the predetermined design elements for one of the footwear design elements can include a color of the upper (e.g., mesh upper), a color of the midsole, a color of the midsole cushioning element, a color of the solid portion of the upper, a color of the clear portion of the upper, a color of the eyestay, and a color of the heel coverstitch (e.g., the upper closure element). In some embodiments, the listed design elements may include a material type, along with the color.

The predetermined design elements in table 400 may further include additional elements to be added to the base footwear structure. Examples of such additional elements include a toc cap element or overlay (including a specified color of the toe cap overlay), a lateral/medial tape element or overlay (including the specified color), an eyestay overlay (including the specified color), and a heel overlay (including the specified color). Each footwear design model may include stored, predetermined data as to the location, shape and/or size, and/or design of the various listed overlays or add-on features. Additional design elements that may be part of the footwear design models may include materials of the different design elements (e.g., overlay material).

It should be noted that in other embodiments, additional or different predetermined design elements than those shown in FIG. 4 are possible.

Returning to FIG. 2, in some embodiments the method at 206 may additionally or alternatively include, at 210, individually selecting one or more design elements from one or more lists of stored design elements. The one or more lists of stored design elements can be stored in the model retrieved at 204. In some embodiments, based on the selected base footwear structure and the corresponding model of the article of footwear, a preset list of available design element options can be stored in the model and available to a user for selection. For example, each model of the article of footwear that can be formed from the selected base footwear structure, may have a different combination of elements that can be modified on or added to the base footwear structure. These different combinations of elements can be stored in the model, and each design element, in some embodiments, may have a list of available options that can be selected from (e.g., a list of possible colors for the upper material, a list of possible colors and materials of an overlay of the upper, or the like).

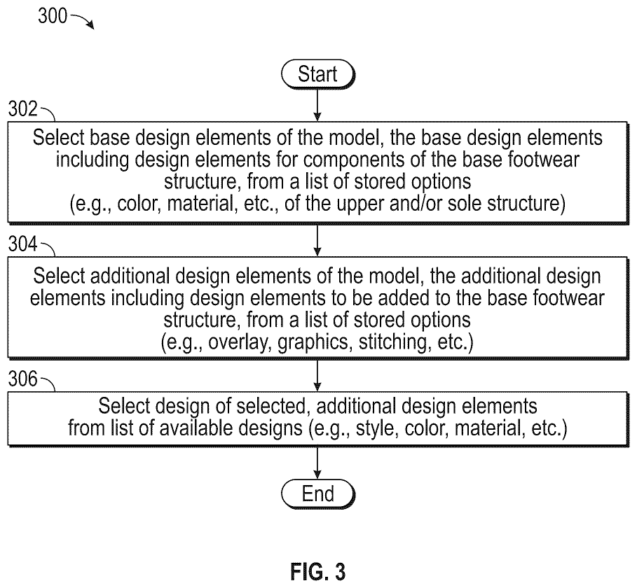

A more detailed, exemplary method 300 for individually selecting design element from one or more lists (or tables, charts, and the like) of stored, available design elements is presented at FIG. 3. Specifically, method 300 begins at 302 by selecting base (e.g., modifiable) design elements of the model, the base design elements including design elements for components of the base footwear structure, from a list of stored options. For example, the base design elements may include one or more lists of available, modifiable design elements stored in the model, where the modifiable design elements are design elements that can be updated on the base footwear structure to form the desired article of footwear. As one example, a base or modifiable design element can include a color, material, or the like, of the upper of the base footwear structure. In another example, the base or modifiable design element can include a color, material, or the like, of one or more components of the sole structure (e.g., the outsole and/or the midsole) of the base footwear structure.

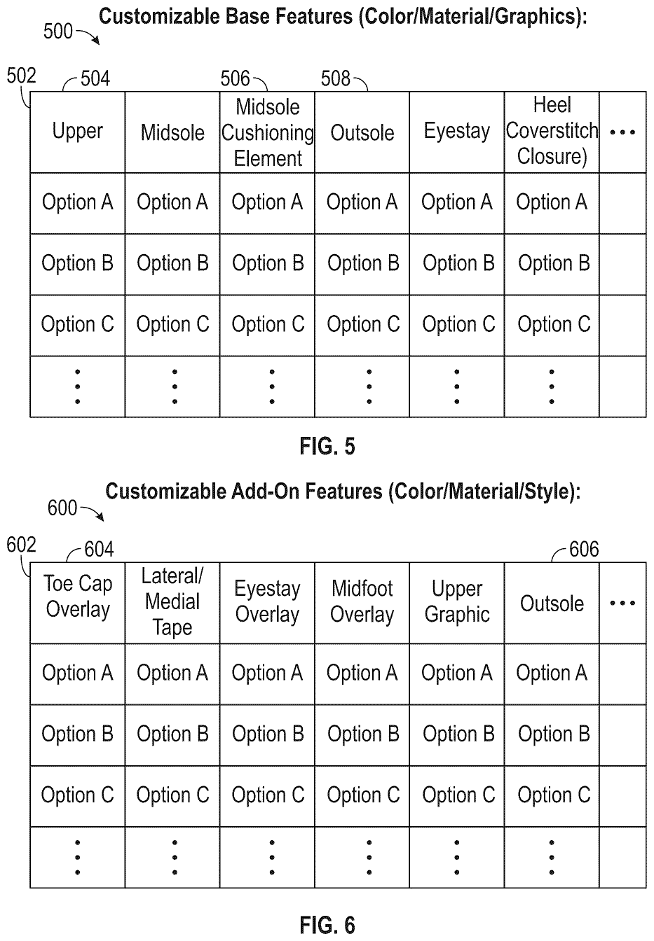

The one or more lists of stored and available base design element options can be stored in the model. As used herein, the term “list” refers to any listing of the desired information (e.g., available base design elements) whether it be arranged in rows, columns, table, or any other visually identifiable arrangement that is accessible to a user, such as a series of images or icons. An example of such a table of available base design element options, stored in the model and available for selection by a user, is shown in FIG. 5. Specifically, FIG. 5 shows an exemplary table 500 including a plurality of components or elements of the base footwear structure in row 502. The design elements (e.g., style) of these components can be modified to form the desired article of footwear. As an example, the modifiable components listed in row 502 include the upper, midsole, midsole cushioning element, outsole, eyestay, and heel coverstitch (e.g., closure). In other embodiments, alternate or additional components of the base footwear structure can be listed in table 500 or a similar table or list.

Each column of table 500 includes a list of design element options for the corresponding component of the base footwear structure. For example, column 504 includes a list of available design element options that can be selected for the upper. As an example, the different listed options (e.g., option A, option B, . . . ) can be a color and/or material of the upper (e.g., white mesh, black mesh, grey leather, or the like). In some embodiments, the default design element(s) of the upper may be the base material and color of the upper stored in the model of the base footwear structure.

As another example, column 506 includes a list of available design element options that can be selected for the midsole cushioning element. For example, the different listed options (e.g., option A, option B, . . . ) can be a color, material, size (e.g., length or height), and/or location (e.g., position along the midsole). As an example, option A in column 506 may be “clear”, while the material, location, and size of the cushioning element is preset within the model, and option B may be “green”.

In some embodiments, when the outsole is part of the base footwear structure, the style or design of the outsole can be included in table 500 or a similar list or table. For example, the list of options in column 508 can include available design element options for the outsole, including one or more of (e.g., a combination of) the color, material, shape, size, and/or patterning of the sole structure. For example, in some embodiments, the shape and size of the sole structure can be predetermined and set within the model, but the color and/or patterning (e.g., indentations, grooves, traction element patterns, or the like) can be selectable and modifiable. In other embodiments, the entire style of the sole structure can be modifiable such that different sole structures (e.g., different overall shapes, sizes, or the like) can be listed within column 508.

Returning to FIG. 3, at 304, method 300 includes selecting one or more additional (e.g., add-on) design elements of the model from a list of stored options. The one or more additional design elements can include design elements to be added to the base footwear structure (e.g., added to the upper).

As used herein, an “additional” or “add-on” design element may be a design element that is not initially present in the selected base footwear structure. However, it can be possible for any add-on design element to be part of a base footwear structure (and thus be a base or modifiable design element of the base footwear structure). For example, an add-on element for a first base footwear structure may be included as a base element of a second base footwear structure. Thus, whether or not a design element is classified as an “add-on” design element, is determined based on whether or not it is part of the base footwear structure (e.g., add-on elements are not initially included in the selected base footwear structure).

As one example, an additional design element can include an overlay for the upper (e.g., overlay positioned at a heel portion, eyestay portion, medial/lateral side portion, toe portion, or midfoot portion of the upper). As another example, the additional design element can include a style of the sole structure (e.g., which may include one or more of a shape, size, patterning, and/or color). As another example, the additional design element can include a graphic, stitching detail, or other design element that can be added to (e.g., printed on, adhered to, or stitched on) the upper of the base footwear structure to form the desired article of footwear.

In some embodiments, the graphic added to the upper or another component of the base footwear structure may include a picture (e.g., image), pattern, line detail, or the like, printed on or adhered to the upper or other component of the base footwear structure. In some embodiments, the graphic may be part of (e.g., integral to) a material of the upper or a material of an overlay.

The one or more lists of stored and available additional design element options can be stored in the model (e.g., as lists, tables, or the like). An example of such a table of available additional (e.g., add-on) design element options, stored in the model and available for selection by a user, is shown in FIG. 6. Specifically, FIG. 6 shows an exemplary table 600 including a plurality of different types of design elements that can be added to the base footwear structure in row 602. Each column of table 600 then includes a plurality of options (e.g., design options) for the selected design element.

As an example, the add-on design elements listed in row 602 include a toe cap overlay, a lateral/medial tape overlay, an eyestay overlay, a midfoot overlay, an upper graphic (e.g., a graphic printed on a portion of the upper), and an outsole style (e.g., structure, shape, size, patterning, and/or the like). In other embodiments, alternate or additional add-on design elements can be listed in table 600 or a similar table or list.

In some embodiments, the selected add-on design element (e.g., overlay) has a predetermined color, material, shape, and/or size. For example, if a user selects “Option B” from the toe cap overlay column 604, Option B may include a toe cap overlay having a predetermined (e.g., preset within the model) shape and location on a toe region of the upper, a predetermined shape and/or size, a predetermined color and/or graphic or pattern, and a predetermined material. In this way, upon selecting “Option B” in column 604, no further selections may be necessary to define the desired overlay to be placed on the base footwear structure to form the desired article of footwear.

As another example, upon selection of “Option A” from the outsole column 606, the selected outsole design element may have a predetermined style and/or shape, such as having a certain structure/shape, with a preset design of patterning (e.g., grooves, indentations, traction elements), color, and material. Examples of different sole structures (including an outsole) selected to add onto a base footwear structure, to create a plurality of distinct articles of footwear, is shown in FIG. 15, as described further below.

Returning to FIG. 3, in some embodiments, method 300 further includes, at 306, selecting a design (e.g., shape, color, material, or the like) of the selected additional design elements from a list of available designs. For example, selecting the design of the selected design element may include selecting one or more of a color, material, shape, and size of the selected overlay from a list of available options stored in the model.

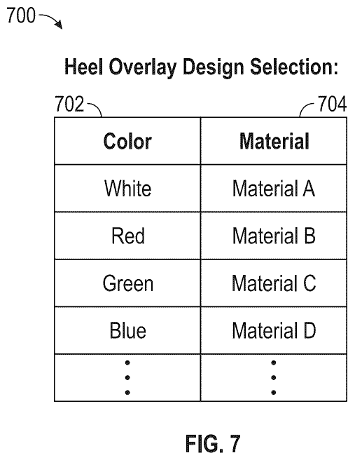

An example of selecting the design of the selected design element is shown in FIG. 7. Specifically, FIG. 7 shows an exemplary table 700 which may be stored in the model of the article of footwear that corresponds with the selected base footwear structure. In the example of table 700, a heel overly design element is selected (e.g., selected at 304 of method 300). Upon selection of the heel overlay, one or more additional design element options, of the heel overlay, may be available for selection. For example, as shown in FIG. 7, table 700 may include a first column 702 for selecting a desired color for the selected heel overlay and a second column 704 for selecting a desired material for the selected heel overlay (e.g., which may include a material type and/or texture of the material). In other embodiments, table 700 can include additional or alternate design options for the selected design element. Additionally, different selected design elements (e.g., heel overlay vs. eyelet overlay vs. toe cap overlay) may have different stored and selectable design options (e.g., an eyelet overlay may have an additional column including a number of and/or which specific eyelets it covers).

In this way, each footwear model may have a predetermined set of tables and/or lists of stored design elements and stored design element options. For example, a first footwear model corresponding with a first base footwear structure may have a different combination of stored design element options than a second footwear model corresponding with a second base footwear structure.

Returning to FIG. 3, following the method at 306, method 300 may end and return to 212 of method 200.

As shown in FIG. 2, the method at 212 includes updating the model based on the one or more selected design elements (including the one or more selected modifiable design elements and the one or more selected additional design elements). In some embodiments, updating the model can include updating the model of the article of footwear that can be formed from the base footwear structure to include the modified design elements. For example, this may include changing the base elements of the base footwear structure, within the model, to have the selected design elements (e.g., updating the color of the upper to be black instead of white or grey). In some embodiments, updating the model can include updating the model of the article of footwear that can be formed from the base footwear structure to include the additional selected design elements. For example, this may include adding the selected design elements (e.g., overlays) to an upper of the base footwear structure, within the model. These updates can then be stored in the model so that the updated model represents the desired article of footwear.

At 214, method 200 includes generating the article of footwear from the updated model. In some embodiments, generating the article of footwear can include employing one or more know manufacturing techniques to generate the article of footwear, from a base footwear structure. For example, the additional selected design elements may be printed or adhered to the base footwear structure using one or more additive manufacturing apparatuses (e.g., a three-dimensional printer) in electronic communication with the computing system. The resulting article of footwear can include all the modified and additional design elements selected by the user. Thus, a unique article of footwear can be more easily and quickly created by modifying elements of and/or adding design elements to a model of base footwear structure.

FIGS. 8A-8B show an exemplary base footwear structure 800 and FIGS. 9A-14B show exemplary, distinct articles of footwear that can be formed by customizing and/or selecting design elements of a model of an article of footwear that can be formed from the base footwear structure 800 of FIGS. 8A-8B.

Turning first to FIGS. 8A-8B, the base footwear structure 800 can include an upper 802, a sole structure 804, and a tongue 806 configured to be coupled to the upper 802. In alternate embodiments, the base footwear structure 800 may comprise the upper 802 alone and not include the sole structure 804 and the tongue 806. In still other embodiments, the base footwear structure 800 may comprise the upper 802 and the tongue 806, but not the sole structure 804.

As shown in FIG. 8A, the upper 802 includes a base material 808 (e.g., mesh material), an upper liner 810, an eyestay 812, a heel coverstitch (also referred to herein as a closure element) 814, and a vamp stitching element 816. In some embodiments, the upper 802 of the base footwear structure 800 may not include the vamp stitching element 816.

In some embodiments, the upper 802 of the base footwear structure 800 can include elements in addition to those shown in FIG. 8A, such as one or more internal support elements (not seen in FIG. 8A).

Additionally, as shown in FIG. 8A, the sole structure 804 includes a midsole 818, a solid portion of the outsole 820, a midsole cushioning element 822, and a clear (e.g., transparent or semi-transparent) portion of the outsole 824. In alternate embodiments, the sole structure may include different or additional elements or components than those shown in FIG. 8A. For example, in alternate embodiments, the sole structure 804 may not include the midsole cushioning element 822 and clear portion of the outsole 824, or these components may have a different configuration (e.g., size, shape, or location along the sole structure 804).

As shown in FIG. 8B, the tongue 806 of the base footwear structure 800 includes a base material 826, which in some embodiments is the same as the base material 808 of the upper 802 (e.g., a mesh material). The tongue 806 further includes a liner 828, a skin 830, and a zigzag stitch 832. In some embodiments, the liner 828 of the tongue 806 is a same material as the upper liner 810.

In some embodiments, the color palette of the base footwear structure 800 may be somewhat neutral (e.g., white, greys, and clear). As one possible example, the base material 808 and tongue base material 826 can be a white mesh material, the upper liner 810 and tongue liner 828 can be a grey color, the tongue skin 830 can be clear, the tongue zigzag stitch 832 can be white, the eyestay 812 can be a clear film material, the heel coverstitch 814 can be a grey color, the vamp stitching element 816 can be a grey color, the midsole 818 and solid portion of the outsole 820 can be a white or off-white color, and the midsole cushioning element 822 and clear portion of the outsole 824 can be clear.

By modifying the design elements (e.g., color, material, or the like) of the above-described components of the base footwear structure 800 and/or adding additional elements to the base footwear structure 800, multiple, distinct articles of footwear can be formed, as shown in the examples of FIGS. 9A-14B. Each of the articles of footwear shown in FIGS. 9A-14B, as described further below, have the same base footwear structure 800. However, each of the articles of footwear shown in FIGS. 9A-14B may include a different combination of modified and/or additional design elements that have been modified on and/or added to the base footwear structure.

As described further below, the different, additional design elements of each article of footwear may comprise different materials and/or colors. The different colors used for the additional design elements are indicated in FIGS. 9A-14B by different cross-hatching.

FIGS. 9A-14B may represent articles of footwear that can be formed via methods 200 and 300 of FIGS. 2-3, as described above. Thus, the modified and/or additional design elements of each article of footwear may be selected by a user from a model of an article of footwear that can be formed from the base footwear structure 800.

Additionally, FIGS. 9A-14B can represent a footwear line, comprising a plurality of articles of footwear that are each distinct (e.g., visually distinct) from one another, but all have the same base footwear structure (e.g., base footwear structure 800 shown in FIGS. 8A-8B).

For example, as shown in FIGS. 9A-9B, a first article of footwear 900 can be formed using the base footwear structure 800. The first article of footwear 900 includes the upper 802 with the same base material 808 and the sole structure 804 having the same colors as in the base footwear structure 800. The design elements of the first article of footwear 900 that have been modified from the base footwear structure 800 include the eyestay 812, which has a different color (e.g., grey), material, and shape than the eyestay of the base footwear structure 800, and the tongue zigzag stitch 832, which is a different color (e.g., red).

The first article of footwear 900 also includes a plurality of additional design elements that have been added to the base footwear structure 800 to form the first article of footwear 900. These additional design elements include a toe cap overlay 902 (which may be red in some embodiments), a lateral/medial tape (e.g., overlay) element 904 (which may be grey in some embodiments), an eyestay overlay 906 (which may be red in some embodiments), and a heel overlay 908 (which may be white in some embodiments). The additional design elements (e.g., overlays) may comprise different materials than the base material 808 of the upper 802. As shown in FIGS. 9A-9B, the first article of footwear 900 has a different visual appearance from the base footwear structure 800, but has a similar overall structure, due to being formed using a model of the base footwear structure 800.

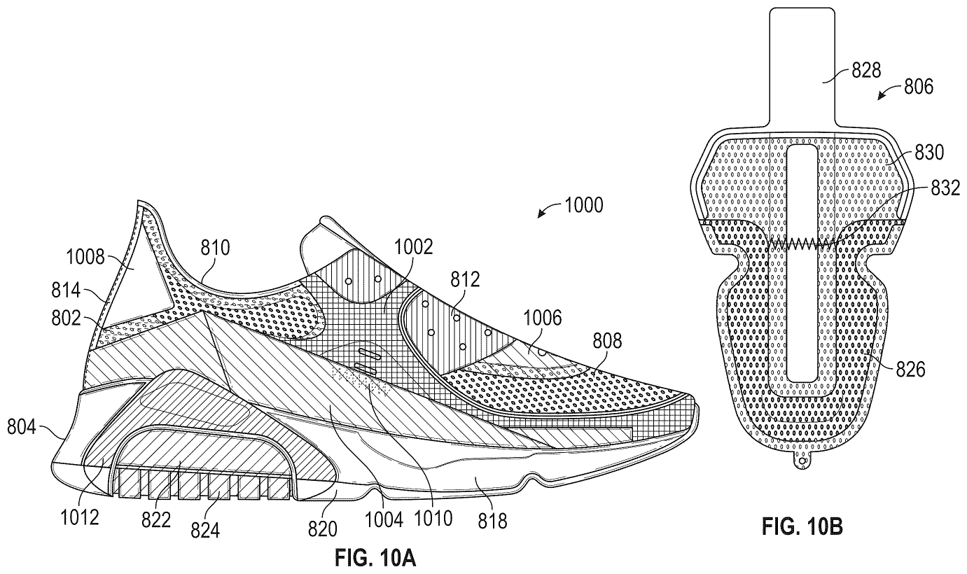

FIGS. 10A-10B show a second article of footwear 1000 formed using the base footwear structure 800. The design elements of the second article of footwear 1000 that have been modified from the base footwear structure 800 include the eyestay 812 (has a different color (red), material, and shape than the eyestay of the base footwear structure 800), the tongue liner 828 (has a different color (white)), and the tongue zigzag stitch 832 (has a different color (red)).

The second article of footwear 1000 also includes a plurality of additional design elements that have been added to the base footwear structure 800 to form the second article of footwear 1000. These additional design elements include a toe cap and midfoot overlay 1002 (which may be black in some embodiments), a lateral/medial tape element (e.g., overlay) 1004 (which may be grey in some embodiments), a bottom eyestay overlay 1006 (which may be grey in some embodiments), a heel overlay 1008 (which may be white in some embodiments), a floating strip zigzag element 1010, and a midsole design element 1012 (which may be red and comprise a different material than the remainder of the midsole 818 in some embodiments). The additional design elements (e.g., overlays) of the second article of footwear 1000 may comprise different materials than the base material 808 of the upper 802.

The second article of footwear 900 has a different visual appearance than the first article of footwear 900, due to the different combinations of modified and additional design elements used, but both the first and second articles of footwear have the same overall structure, due to being formed using the model of the base footwear structure 800. As an example, the lateral/medial tape element 1004 of the second article of footwear 1000 may be a same color and/or material as the lateral/medial tape element 904 of the first article of footwear; however, the lateral/medial tape element 1004 is a different size and shape than the lateral/medial tape element 904 and is used in conjunction with different overlays, thereby giving the second article of footwear 1000 a different visual appearance and design (e.g., style) than the first article of footwear 900.

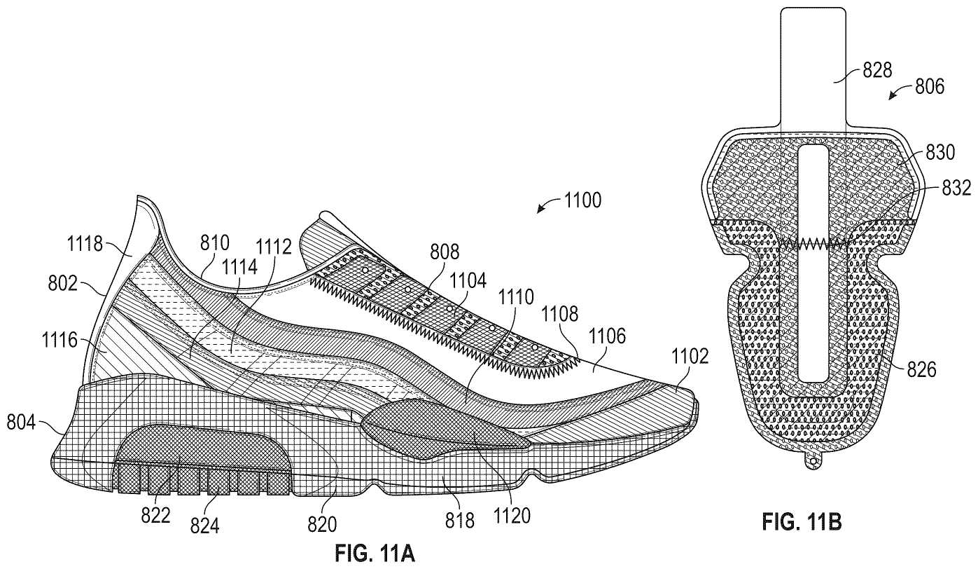

FIGS. 11A-11B show a third article of footwear 1100 formed using the base footwear structure 800. The design elements of the third article of footwear 1100 that have been modified from the base footwear structure 800 include the base material 808, the tongue base material 826, the solid portion of the outsole 820, and the midsole 818 (all have a different color than the base footwear structure, e.g., black). Additional modified design elements include the upper liner 810 (has a different color, e.g., white), the tongue liner 828 (has a different color, e.g., white), the tongue zigzag stitch 832 (has a different color, e.g., red), and the midsole cushioning element 822 and the clear portion of the outsole 824 (have a different color, e.g., green).

The third article of footwear 1100 also includes a plurality of additional design elements that have been added to the base footwear structure 800 to form the third article of footwear 1100. These additional design elements include a toe cap element 1102 (e.g., overlay or covering material element), an eyestay overlay 1104, a midfoot shroud 1106, a midfoot shroud zigzag stitch 1108, a midfoot overlay 1110, a middle layer overlay 1112, a bottom layer overlay 1114, a lateral/medial tape element 1116, a heel overlay 1118, and a forefoot material or cushioning element 1120. As introduced above, the various additional design elements of the third article of footwear may comprise different materials and/or may have different colors than one another (e.g., various shades of grey, green, red, and the like), as indicated by the different cross-hatching of the design elements.

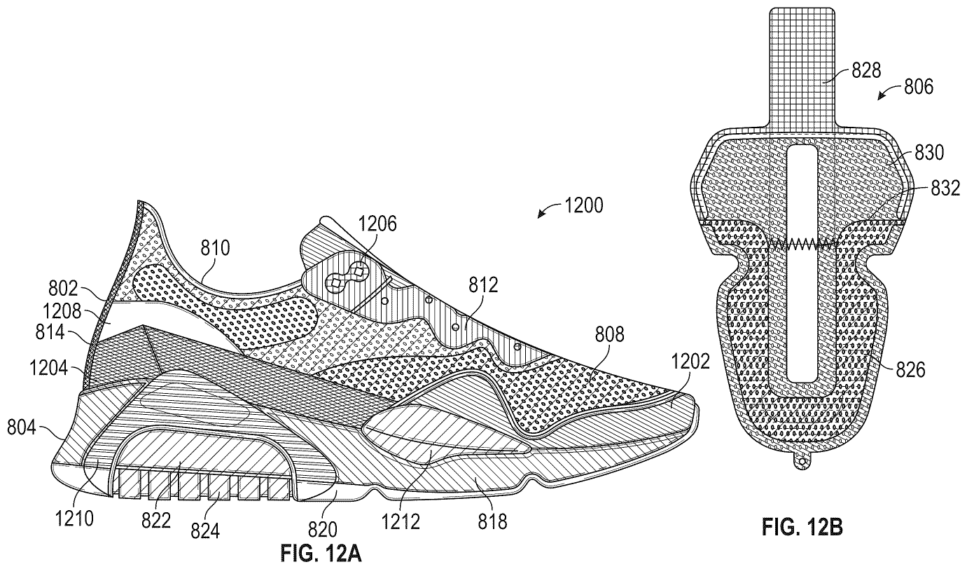

FIGS. 12A-12B show a fourth article of footwear 1200 formed using the base footwear structure 800. The design elements of the fourth article of footwear 1200 that have been modified from the base footwear structure 800 include the base material 808, the tongue base material 826, the upper liner 810, the tongue liner 828, and the tongue zigzag stitch 832 (all have a different color than the base footwear structure, e.g., black). Additional modified design elements include the eyestay 812 (has a different color (grey), material, and shape), the heel coverstitch (has a different color, e.g., green), and the midsole 818 (has a different color, e.g., off-white).

The fourth article of footwear 1200 also includes a plurality of additional design elements that have been added to the base footwear structure 800 to form the fourth article of footwear 1200. These additional design elements include a toe cap overlay 1202, a lateral/medial tape element 1204, an eyestay overlay 1206, a heel overlay 1208, a midsole design element 1210, and a forefoot material or cushioning element 1212. The additional design elements (e.g., overlays) of the fourth article of footwear 1200 may comprise different materials than the base material 808 of the upper 802 and, in some embodiments, the other articles of footwear shown in FIGS. 9A-14B. For example, the lateral/medial tape element 1204 may comprise a foil-like material instead of a fabric-type material.

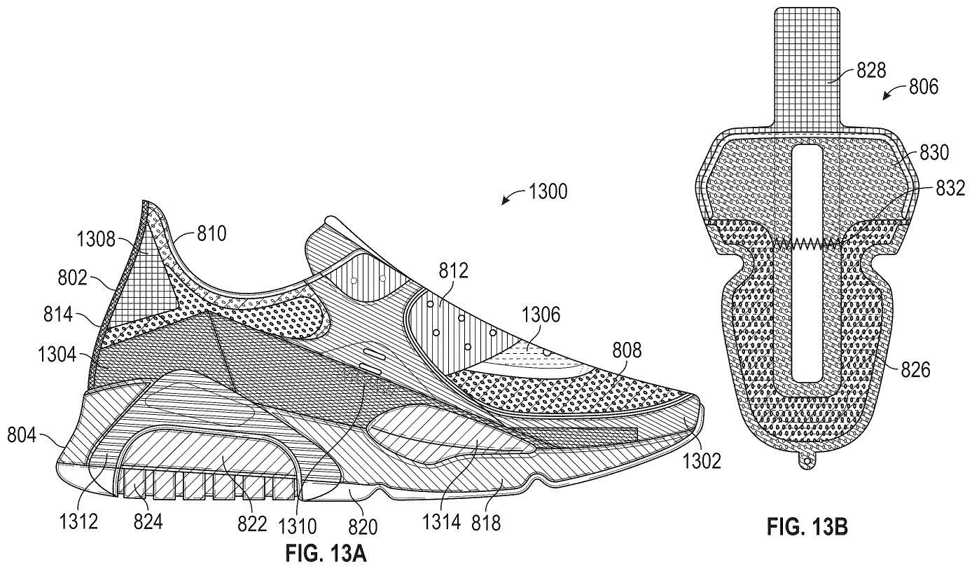

FIGS. 13A-13B show a fifth article of footwear 1300 formed using the base footwear structure 800. The design elements of the fifth article of footwear 1300 that have been modified from the base footwear structure 800 include the base material 808, the tongue base material 826, the upper liner 810, the tongue liner 828, and the tongue zigzag stitch 832 (all have a different color, e.g., black). Additional modified design elements include the eyestay 812 (has a different color (grey), material, and shape), the heel coverstitch (has a different color, e.g., green), and the midsole 818 (has a different color, e.g., off-white).

The fifth article of footwear 1300 also includes a plurality of additional design elements that have been added to the base footwear structure 800 to form the fifth article of footwear 1300. These additional design elements include a toe cap and midfoot overlay 1302, a lateral/medial tap element 1304, a bottom eyestay overlay 1306, a heel overlay 1308, a floating strip zigzag element 1310, a midsole design element 1312, and a forefoot material or cushioning element 1314.

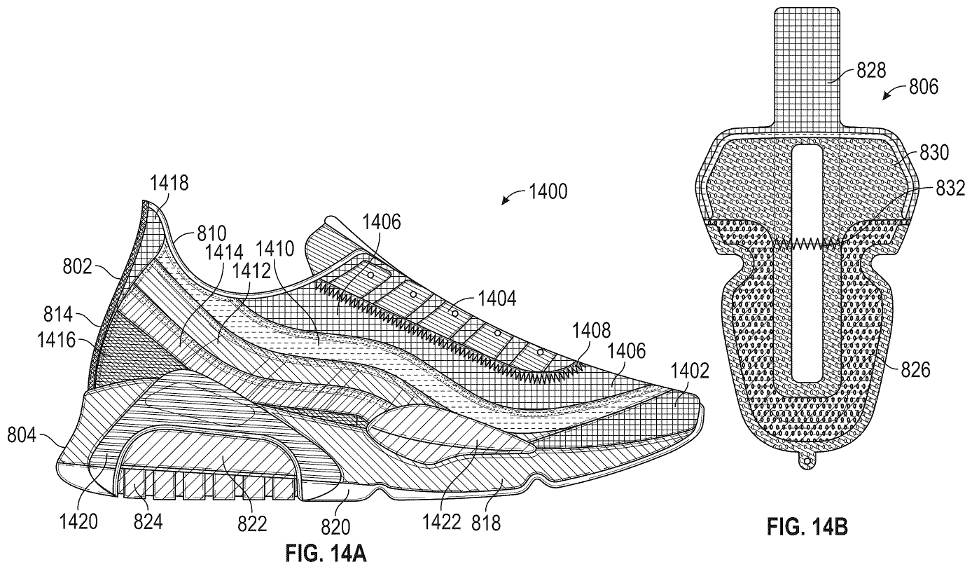

FIGS. 14A-14B show a sixth article of footwear 1400 formed using the base footwear structure 800. The design elements of the sixth article of footwear 1400 that have been modified from the base footwear structure 800 include the base material 808 (though it is not visible in FIG. 14A due to the plurality of overlays, as noted further below), the tongue base material 826, the upper liner 810, the tongue liner 828, and the tongue zigzag stitch 832 (all have a different color, e.g., black). Additional modified design elements include the heel coverstitch (has a different color, e.g., green) and the midsole 818 (has a different color, e.g., off-white).

The sixth article of footwear 1400 also includes a plurality of additional design elements that have been added to the base footwear structure 800 to form the sixth article of footwear 1400. These additional design elements include a toe cap overlay 1402, an eyestay overlay 1404, a midfoot shroud 1406 (which extends underneath the eyestay overlay 1404, in place of eyestay 812), a midfoot shroud zigzag stitch 1408, a midfoot overlay 1410, a middle layer overlay 1412, a bottom layer overlay 1414, a lateral/medial tape element 1416, a heel overlay 1418, a midsole design element 1420, and a forefoot material or cushioning element 1422.

In this way, FIGS. 9A-14B show six exemplary, distinct articles of footwear. Each of these six articles of footwear are formed using a same base footwear structure 800 (comprising the upper 802, sole structure 804, and tongue 806, for example) and different combinations of modified and additional design elements. The different overlays or design elements described above with reference to FIGS. 9A-14B can comprise different colors and/or materials, and even the same types of overlays (e.g., toe cap overlay) may have different sizes, shapes, and orientations on the different articles of footwear.

It should be noted that the above-described design elements (e.g., overlays, cushioning elements, stitching details, and the like) are exemplary and not meant to be limiting. In alternate embodiments, articles of footwear formed from the same base footwear structure may have different combinations of different design elements, forming additional distinct articles of footwear having different visual appearances than those articles of footwear shown in FIGS. 9A-14B.

FIG. 15 shows another exemplary embodiment of a base footwear structure which may be used to create multiple, differently designed and distinct articles of footwear. Specifically, FIG. 15 shows a schematic 1500 illustrating three exemplary articles of footwear, including a first article of footwear 1502, a second article of footwear 1504, and a third article of footwear 1506, each formed from a same base footwear structure 1510.

The base footwear structure 1510 includes an upper 1512 that is configured to be coupled to a sole structure. However, the sole structure shown coupled to the upper 1512 is not part of the base footwear structure 1510 in the embodiment of FIG. 15. In alternate embodiments, the sole structure can additionally be part of the base footwear structure 1510.

The upper 1512 can comprise a base, first material 1540.

As shown in schematic 1500, each of the first article of footwear 1502, the second article of footwear 1504, and the third article of footwear 1506 have the same upper 1512 (e.g., overall structure, including the same shape and size). However, the materials and/or the graphics of the upper 1512 may be modified in each of the first article of footwear 1502, the second article of footwear 1504, and the third article of footwear 1506 from the base footwear structure 1510.

Additionally, each of the first article of footwear 1502, the second article of footwear 1504, and the third article of footwear 1506 have different sole structures. Thus, the style or design of the sole structure may be an additional design element added to the base footwear structure 1510 to form each of the first article of footwear 1502, the second article of footwear 1504, and the third article of footwear 1506. The style of the sole structure may include one or more of a shape, size, and patterning (e.g., indentations, grooves, traction element patterns, or the like) of the sole structure.

For example, the first article of footwear 1502 has a first sole structure 1514. As shown in FIG. 15, the first sole structure 1514 includes a first cushioning element 1516 positioned at a location on the first sole structure 1514 that is closer to the toe portion than the heel portion of the first article of footwear 1502. The first sole structure 1514 also has a heel portion 1518 that extends further outward, away from the first article of footwear 1502, than a heel portion of the upper 1512.

Additionally, the upper 1512 of the first article of footwear 1502 comprises the same, first material 1540 as the base footwear structure 1510. However, the first material 1540 of the first article of footwear 1502 includes first graphic elements 1542. In some embodiments, the first graphic elements 1542 may be printed on the first material 1540. Additionally, the first article of footwear 1502 includes a first heel overlay 1544 with a graphic pattern.

The second article of footwear 1504 has a second sole structure 1520 that is distinct (e.g., visually distinct) from the first sole structure 1514. The second sole structure 1520 includes an outsole with a traction surface 1522 (e.g., ground-facing surface) that includes a plurality of indentations and a midsole including a plurality of grooves 1524. As shown in FIG. 15, the heel portion of the second sole structure 1520 does not extend as far outward as the first sole structure 1514. Further, the second sole structure 1520 does not include a cushioning element.

Additionally, the upper 1512 of the second article of footwear 1504 comprises a second material 1546 that is different than the first material 1540 of the base footwear structure 1510. The second material 1546 includes a second graphic element 1548. The second article of footwear 1504 also includes a second heel overlay 1550 that does not include a graphic pattern.

The third article of footwear 1506 has a third sole structure 1526 that is distinct (e.g., visually distinct) from each of the first sole structure 1514 and the second sole structure 1520. The third sole structure 1526 includes a profile with a more pronounced curvature on its ground-facing surface 1528 (as compared to this surface on the first and second sole structures), a first set of lower grooves 1530, a second set of upper grooves 1532, and a heel portion 1534 that extends outward from a heel portion of the upper 1512. In this way, the overall shape and patterning of the third sole structure 1526 is different than the first sole structure 1514 and the second sole structure 1520.

Additionally, the upper 1512 of the third article of footwear 1506 comprises the same, first material 1540 as the base footwear structure 1510. However, the first material 1540 of the third article of footwear 1506 includes a third graphic element 1552. The third graphic element 1552 may be similar in geometry to the second graphic element 1548. In some embodiments, the third graphic element 1552 may have a different color than the second graphic element 1548. Additionally, the third article of footwear 1506 includes the first heel overlay 1544.

In this way, different articles of footwear that are visually distinct from one another (and thus, unique) can be formed by modifying the materials and/or graphics of the upper and/or adding different styles of sole structures to the upper of a base footwear structure.

In some embodiments, a base footwear structure (such as the base footwear structure 110 shown in FIG. 1, the base footwear structure 800 shown in FIG. 8A, and/or the base footwear structure 1510 shown in FIG. 15) may be formed as a blend of two or more articles of footwear. For example, the base footwear structure may be formed as a base, or common, structure to multiple, visually distinct articles of footwear.

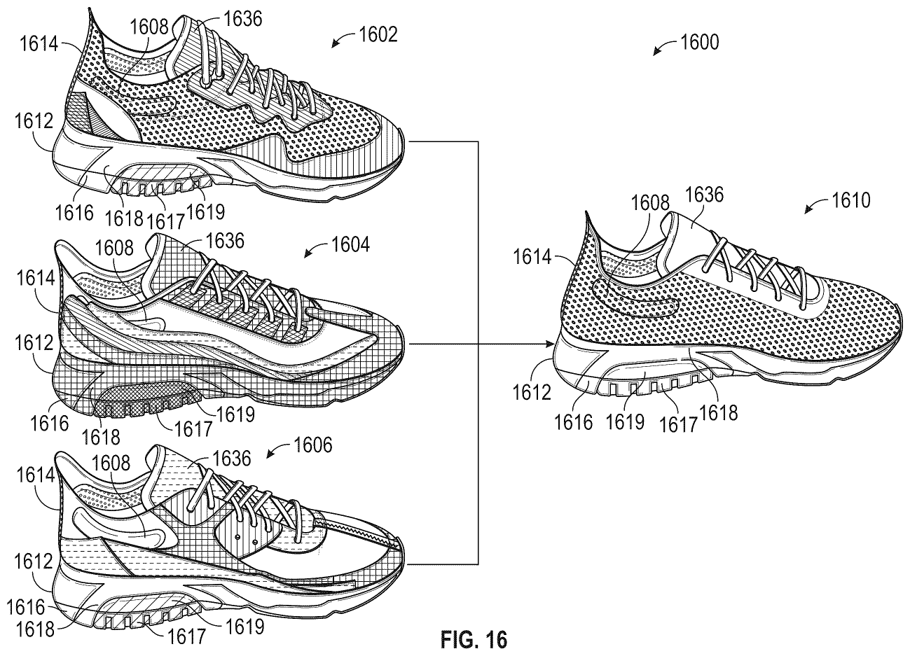

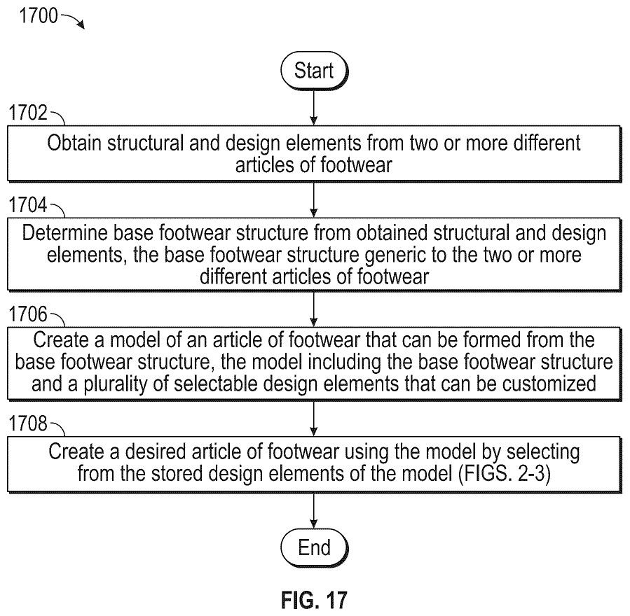

As an example, FIG. 16 is a schematic 1600 illustrating how three visually distinct articles of footwear, including a first article of footwear 1602, a second article of footwear 1604, and a third article of footwear 1606, can be used to form a base footwear structure 1610 which has a structure that is common to all three articles of footwear. As described further below with reference to FIG. 17, the base footwear structure 1610 may be determined by evaluating the structural elements and design elements of each of the first article of footwear 1602, the second article of footwear 1604, and the third article of footwear 1606 (as described above with reference to FIG. 1), and then finding the structure that is generic to all of these articles of footwear such that each of the three articles of footwear may be generated by modifying the design elements of or adding design elements to the base footwear structure 1510 (e.g., as explained above with reference to FIG. 1).

Turning to FIG. 17, a method 1700 for forming a base footwear structure for an article of footwear is shown. Method 1700 begins at 1702 by obtaining structural and design elements from two or more different (e.g., visually distinct) articles of footwear. As an example, the structural and design elements from the first article of footwear 1602, the second article of footwear 1604, and the third article of footwear 1606 in FIG. 16 may be obtained. For example, the structural elements of the articles of footwear may include a structure (e.g., overall geometry, including shape and size, support structure elements, and the like) of the upper, sole structure (e.g., including an outsole and midsole in some embodiments), and/or tongue of each of the articles of footwear. The design elements of the articles of footwear may include any of the design elements discussed herein, such as materials, colors, patterning, graphics, and the like, of the upper (e.g., including the base material, overlays, and stitching elements), sole structure, and tongue.

Obtaining the structural and design elements at 1702 can include obtaining all the structural and design elements for each of the two or more articles of footwear (e.g., the first article of footwear 1602, the second article of footwear 1604, and the third article of footwear 1606 in FIG. 16) and inputting them into a list, database, or other organizational system. In one example, this obtaining may be done automatically by a processing system (e.g., a processor of a computing system, such as the computing system described below with reference to FIG. 18). For example, the computing system may receive data (e.g., inputs from a user or an imaging system which may include an image, computer aided design model, and/or a list or table of the structural and design elements of each of the two or more articles of footwear) on the structural and design elements of each of the two or more different articles of footwear. In one embodiment, the obtaining the structural and design elements may be performing by an imaging system that is configured to capture a digital image of each article of footwear. In another embodiment, this obtaining may be done by a user and input into a computing system or compiled manually for reference.

Method 1700 continues from 1702 to 1704 to determine the base footwear structure from the obtained structural and design elements, where the base footwear structure is generic to the two or more different articles of footwear. For example, in FIG. 16, the structural and design elements that are common to each of the first article of footwear 1602, the second article of footwear 1604, and the third article of footwear 1606 can be used to form the base footwear structure 1610. Thus, the method at 1704 can include determining the common structural and/or design elements for the two or more different articles of footwear, from the elements obtained at 1702, and generating the base footwear structure with the determined common structural and/or design elements

In the example shown in FIG. 16, these common elements may include an upper 1614 having the shape shown in FIG. 16 and a sole structure 1612 including an outsole 1616 and a midsole 1618 having the shape and patterning (e.g., indentation and ground-facing surface shape) shown in FIG. 16. The common elements may further include one or more internal support and/or reinforcement elements, such as the reinforcement element 1608, of the upper 1614. The common elements may further include a midsole cushioning element 1619 and a semi-transparent portion 1617 of the outsole 1616. The common elements may further include a tongue (having a common tongue structure, for example) 1636.

These example, common structural and design elements can then be combined to form the base footwear structure (e.g., the base footwear structure 1610 shown in FIG. 16).

In some embodiments, the determining the base footwear structure at 1704 can be performed manually, by constructing the base footwear structure from the determined common structural and design elements. Constructing the base footwear structure can include constructing a physical model of the base footwear structure and/or constructing a computer model of the base footwear structure (e.g., via a computing system, as described herein, and software, such as a computer aided design software).

In other embodiments, the determining the base footwear structure at 1704 can be performed automatically by one or more processors of the computing system. For example, the one or more processors can determine the common structural and design elements from the structural and design elements of each article of footwear determined or received at 1702. The one or more processors can then determine or virtually construct the base footwear structure from the determined common structural and design elements.

At 1706, method 1700 includes creating a model of an article of footwear that can be formed from the base footwear structure determined at 1704. In some embodiments, the model can include the base footwear structure and a plurality of selectable design elements that can be customized (e.g., modified) on and/or added to the base footwear structure to form a desired article of footwear.

In some embodiments, creating the model of the article of footwear can be performed via the computing system using the base footwear structure, corresponding software, such as computer aided design software, and/or databases (e.g., stored in one or more storage devices of the computing system or accessible via a network) of possible design elements for an article of footwear that can be formed from the base footwear structure. For example, based on the components (e.g., upper structure, sole structure components and structure, and the like) of the base footwear structure, a processor can determine which design elements are possible and may be selected from to create a desired article of footwear from the base footwear structure. Examples of possible design element options that can be included in the model and selected from by a user are described above with reference to FIGS. 2-7.

Thus, after creating the model of the article of footwear at 1706, method 1700 can proceed to 1708 to create a desired (e.g., customized or unique) article of footwear using the model and one or more received inputs of desired design elements within the model from a user. For example, in some embodiments, the method at 1706 may include presenting design element options of the model to a user and receiving user inputs as to what design elements are desired for the final article of footwear. The desired article of footwear, including the selected design elements, can then be created, the final article of footwear having the base footwear structure. Further details on the method at 1706 are presented above with reference to FIGS. 2-3.

In this way, a base footwear structure may be a blend of structural elements (e.g., geometries) and design elements of two or more different (e.g., visually distinct) articles of footwear. As described herein, the base footwear structure can comprise more generic materials and design elements that can then be customized by changing details of the base footwear structure (e.g., changing colors, materials, and patterns) and/or adding design elements to the base footwear structure (e.g., adding overlays, stitching details, graphics, and the like). As a result, multiple articles of footwear that are distinct from one another and have unique designs may be created using the same base footwear structure. This approach may save time, money, and effort in the creation and manufacturing of many different articles of footwear, as desired by a consumer.

### Exemplary Control Systems and Computing Systems

As discussed above, the methods and lines of articles of footwear described herein can result in many distinct articles of footwear (each having a different visual style or design) being produced in a more time efficient manner and with reduced manufacturing effort. In some embodiments, at least some of the methods for forming the distinct articles of footwear from a base footwear structure and for forming the base footwear structure may be implemented with a computing system, in conjunction with inputs from a user.

FIG. 18 depicts a generalized example of a suitable computing system 1800 in which the above-described innovations may be implemented. The computing system 1800 is not intended to suggest any limitation as to scope of use or functionality, as the innovations may be implemented in diverse general-purpose or special-purpose computing systems. For example, the computing system 1800 can be used to implement hardware and software.

With reference to FIG. 18, the computing system 1800 includes one or more processing units 1810, 1815, non-volatile memory 1820, and memory 1825. In FIG. 18, this basic configuration 1830 is included within a dashed line. The processing units 1810, 1815 execute computer-executable instructions, including instructions for forming a base footwear structure from multiple different articles of footwear, creating a model of an article of footwear that can be formed from the base footwear structure, and creating customized articles of footwear using the same model of the article of footwear that can be formed from the base footwear structure, as disclosed herein (e.g., as described above with reference to FIGS. 2, 3, and 17). A processing unit can be a general-purpose central processing unit (“CPU”), processor in an application-specific integrated circuit (“ASIC”), or any other type of processor. In a multi-processing system, multiple processing units execute computer-executable instructions to increase processing power. For example, FIG. 18 shows a central processing unit 1810 as well as a graphics processing unit (“GPU”) or co-processing unit 1815. The tangible memory 1825 may be volatile memory (e.g., registers, cache, RAM), non-volatile memory (e.g., ROM, EEPROM, flash memory, etc.), or some combination of the two, accessible by the processing unit(s). The memory 1825 stores software 1880 implementing one or more innovations described herein, in the form of computer-executable instructions suitable for execution by the processing unit(s).

A computing system may have additional features. For example, the computing system 1800 includes storage 1840, one or more input devices 1860, one or more output devices 1850, and one or more communication connections 1870. An interconnection mechanism (not shown) such as a bus, controller, or network interconnects the components of the computing system 1800. Typically, operating system software (not shown) provides an operating environment for other software executing in the computing system 1800, and coordinates activities of the components of the computing system 1800.

The tangible storage 1840 may be removable or non-removable, and includes magnetic disks, magnetic tapes or cassettes, CD-ROMs, DVDs, or any other medium which can be used to store information and which can be accessed within the computing system 1800. The storage 1840 stores instructions for the software 1880 for implementing one or more innovations described herein.

The input device(s) 1860 may be a touch input device such as a keyboard or other devices that provides input to the computing system 1800 (e.g., a mouse or imaging device). For video encoding, the input device(s) 1860 may be a camera with an image sensor, video card, TV tuner card, or similar device that accepts video input in analog or digital form, or a CD-ROM, CD-RW, DVD, or Blu-Ray that reads video samples into the computing system 1800. In some embodiments, imaging devices capable of capturing image information (e.g., image information of two or more different articles of footwear, such as those shown in FIG. 16) may convert captured, optical images into information transmitted via electrical signals to the computing system. Upon receiving these electrical signals, the one or more processors 1810, 1815 of the computing system can use this information to determine a variety of information about the articles of footwear (e.g., structural and design elements, including their position, orientation, color, graphics, and the like) that may be visible to the imaging device. This information can be used to determine the base footwear structure and create the model of the article of footwear that can be formed from the base footwear structure, as described above with reference to FIG. 17.

The output device(s) 1850 may be any device that receives an output or that is controlled by the computing system 1800 by instructions, or a series of instructions, from the computing system 1800 (such as a robotic system, three-dimensional printing system, and/or other systems used to form or build an article of footwear according to the updated computer models of the articles of footwear described herein).

The communication connection(s) 1870 enable communication over a communication medium (e.g., a connecting network) to another computing entity. The communication medium conveys information such as computer-executable instructions, compressed graphics information, video, or other data in a modulated data signal. The communication connection(s) 1870 are not limited to wired connections (e.g., megabit or gigabit Ethernet, Infiniband, Fibre Channel over electrical or fiber optic connections) but also include wireless technologies (e.g., RF connections via Bluetooth, WiFi (IEEE 802.11a/b/n), WiMax, cellular, satellite, laser, infrared) and other suitable communication connections for providing a network connection for the disclosed agents, bridges, and agent data consumers. In a virtual host environment, the communication(s) connections can be a virtualized network connection provided by the virtual host.

Some embodiments of the disclosed methods can be performed using computer-executable instructions implementing all or a portion of the disclosed technology in a computing cloud 1890. For example, disclosed computer-readable instructions can be executed by processors located in the computing environment 1830, or the disclosed computer-readable instructions can be executed on servers located in the computing cloud 1890.

Computer-readable media are any available media that can be accessed within a computing environment 1800. By way of example, and not limitation, with the computing environment 1800, computer-readable media include memory 1820 and/or storage 1840. As should be readily understood, the term computer-readable storage media includes the media for data storage such as memory 1820 and storage 1840, but does not include transmission media such as modulated data signals or other transitory signals.

The innovations can be described in the general context of computer-executable instructions, such as those included in program modules, being executed in a computing system on a target real or virtual processor. Generally, program modules include routines, programs, libraries, objects, classes, components, data structures, etc. that perform particular tasks or implement particular data types. The functionality of the program modules may be combined or split between program modules as desired in various embodiments. Computer-executable instructions for program modules may be executed within a local or distributed computing system.

### Additional Examples of the Disclosed Technology

Additional examples of the disclosed technology are enumerated below.

Example 1. A method of forming an article of footwear, comprising: selecting a base footwear structure, the base footwear structure comprising an upper that is configured to be coupled to a sole structure; retrieving a model of an article of footwear that can be formed from the selected base footwear structure; selecting one or more design elements from a plurality of available design elements associated with the model, wherein the one or more design elements are design elements that can be added to or modified on the base footwear structure to form the article of footwear; updating the model based on the one or more selected design elements; and generating the article of footwear from the updated model.

Example 2. The method of any example herein, particularly example 1, wherein the base footwear structure further comprises the sole structure, the sole structure coupled to the upper.

Example 3. The method of any example herein, particularly example 2, wherein the sole structure comprises a midsole and an outsole and wherein the one or more selected design elements includes a cushioning element for the midsole.

Example 4. The method of any example herein, particularly example 2, wherein the sole structure comprises a cushioning element and wherein the one or more selected design elements includes a color of the cushioning element.

Example 5. The method of any example herein, particularly any one of the preceding examples, wherein the upper comprises a base material, an internal support structure comprising one or more reinforcement elements and linings, a closure element arranged at a heel portion of the upper, and a lacing region, and wherein the one or more selected design elements includes the selection of one or more structures that define the one or more reinforcement elements and linings, the closure element, and the lacing region

Example 6. The method of any example herein, particularly example 5, wherein the lacing region comprises an eyestay, and wherein the one or more selected design elements comprises the selection of a structure of the eyestay from a plurality of available eyestay structures.

Example 7. The method of any example herein, particularly any of the preceding examples, wherein selecting the one or more design elements includes selecting a footwear design model from a plurality of available footwear design models stored in the model, wherein each footwear design model includes a combination of predetermined design elements to be updated on and/or added to the base footwear structure.

Example 8. The method of any example herein, particularly any one of examples 1-6, wherein selecting the one or more design elements includes individually selecting one or more design elements from one or more lists of design elements stored in the model.

Example 9. The method of any example herein, particularly any one of the preceding examples, wherein the one or more selected design elements include one or more of a color of the upper, a material of the upper, a color of the sole structure, a style of the sole structure, and an overlay for the upper.

Example 10. The method of any example herein, particularly example 9, wherein the style of the sole structure includes one or more of a shape, size, and patterning of the sole structure.

Example 11. The method of any example herein, particularly any one of the preceding examples, wherein the one or more selected design elements includes an overlay for the upper and wherein the overlay is an overlay configured to be positioned on one of a heel portion, an eyestay, a medial/lateral side portion, a toe portion, or a midfoot portion of the upper.

Example 12. The method of any example herein, particularly example 11, wherein the selected overlay has a predetermined color, material, shape, and size.

Example 13. The method of any example herein, particularly example 11, wherein the selecting the one or more design elements further comprises selecting one or more of a color, material, shape, and size of the selected overlay from a list of available options stored in the model.

Example 14. The method of any example herein, particularly any one of the preceding examples, wherein the upper comprises a mesh material.

Example 15. The method of any example herein, particularly any one of the preceding examples, wherein the one or more selected design elements includes a sole structure having a predetermined style, the predetermined style of the selected sole structure including one or more of a shape, size, and patterning of the sole structure.

Example 16. The method of any example herein, particularly any one of the preceding examples, wherein selecting the base footwear structure includes selecting one base footwear structure from a finite number of distinct base footwear structures, wherein each of the distinct base footwear structures includes an upper configured to be coupled to a sole structure, and wherein each of the distinct base footwear structures has a differently structured upper from each of the other distinct base footwear structures in the list of multiple base footwear structures.

Example 17. The method of any example herein, particularly any one of the preceding examples, wherein selecting the base footwear structure includes selecting one base footwear structure from a finite number of distinct base footwear structures, wherein each of the distinct base footwear structures includes an upper and a sole structure coupled to the upper, and wherein each of the distinct base footwear structures has a sole structure that is distinct from each of the other distinct base footwear structures.

Example 18. A method of forming an article of footwear, comprising: selecting a base footwear structure, the base footwear structure comprising a sole structure and an upper, the upper coupled to the sole structure; retrieving a model of an article of footwear that can be formed from the selected base footwear structure; selecting one or more modifiable design elements from a first list of available modifiable design elements stored in the model, wherein the one or more modifiable design elements are design elements that can be updated on the base footwear structure to form the article of footwear; selecting one or more add-on design elements from a second list of available add-on design elements stored in the model, wherein the one or more add-on design elements are design elements that can be added to the base footwear structure to form the article of footwear; updating the model based on the one or more selected modifiable design elements and the one or more selected add-on design elements; and generating the article of footwear from the updated model.

Example 19. The method of any example herein, particularly example 18, wherein selecting the base footwear structure includes selecting one base footwear structure from a finite list of multiple, distinct base footwear structures.

Example 20. The method of any example herein, particularly any one of examples 18 and 19, wherein the one or more selected modifiable design elements include one or more of a color and material of the upper.

Example 21. The method of any example herein, particularly any one of examples 18-20, wherein the one or more selected modifiable design elements include one or more of a color, material, and patterning of one or more components of the sole structure.

Example 22. The method of any example herein, particularly any one of examples 18-21, wherein the sole structure comprises an outsole and a midsole, the midsole comprising a midsole cushioning element, and wherein the one or more selected modifiable design elements include one or more of a color, material, size, and location of the midsole cushioning element.

Example 23. The method of any example herein, particularly any one of examples 18-22, wherein the one or more selected add-on design elements include an overlay for the upper.

Example 24. The method of any example herein, particularly example 23, further comprising selecting a design of the selected overlay, the design including one or more of a color, material, and graphic for the overlay.

Example 25. The method of any example herein, particularly any one of examples 18-24, wherein the one or more selected add-on design elements include a style of the sole structure, the style including one or more of a shape, size, patterning, and color of the sole structure.

Example 26. The method of any example herein, particularly any one of examples 18-25, wherein the one or more selected add-on design elements include one or more of a graphic and stitching detail that is added to the upper.

Example 27. The method of any example herein, particularly any one of examples 18-26, wherein updating the model based on the one or more selected modifiable design elements and the one or more selected add-on design elements includes updating base design elements of the base footwear structure to have the selected modifiable design elements and adding the selected add-on design elements to the base footwear structure, within the model, and further comprising, storing the updates within the model.

Example 28. A footwear line, comprising: a plurality of distinct articles of footwear that have a same base footwear structure, the base footwear structure comprising at least an upper configured to be coupled to a sole structure; wherein each of the distinct articles of footwear includes a different design element added to the base footwear structure such that each article of footwear of the plurality of articles of footwear is structurally distinct.

Example 29. The footwear line of any example herein, particularly example 28, wherein the upper of the base footwear structure comprises a base material and shape.

Example 30. The footwear line of any example herein, particularly any one of examples 28 and 29, wherein the base footwear structure further comprises a sole structure.

Example 31. The footwear line of any example herein, particularly any one of examples 28-30, wherein the different design element includes an overlay and wherein the overlay added to each of the plurality of distinct articles of footwear has at least one of a different position on the article of footwear, a different color, a different shape, a different size, or a different graphic than each other overlay added to the other articles of the plurality of distinct articles of footwear.

Example 32. The footwear line of any example herein, particularly any one of examples 28, 29, and 31, wherein the different design element includes a sole structure and wherein the sole structure added to each of the plurality of distinct articles of footwear has at least one of a different shape, size, and patterning than each other sole structure added to the other articles of the plurality of distinct articles of footwear.

Example 33. The footwear line of any example herein, particularly any one of examples 28-32, wherein the different design element includes a graphic and wherein the graphic added to each of the plurality of distinct articles of footwear is visually different than each other graphic added to the other articles of the plurality of distinct articles of footwear.

Example 34. A method of forming a base footwear structure for an article of footwear, comprising: obtaining a plurality of structural and design elements from two or more different articles of footwear that are visually distinct; and determining the base footwear structure from the obtained plurality of structural and design elements, wherein the base footwear structure comprises an upper configured to be coupled to a sole structure and is generic to the two or more different articles of footwear.

Example 35. The method of any example herein, particularly example 34, wherein determining the base footwear structure includes determining structural and design elements out of the obtained plurality of structural and design elements that are common to the two or more different article of footwear and constructing the base footwear structure from the determined common structural and design elements.

Example 36. The method of any example herein, particularly any one of examples 34 and 35, further comprising creating a model of an article of footwear that can be formed from the base footwear structure, the model including the base footwear structure and a plurality of selectable design elements that can be selected by a user and modified on or added to the base footwear structure to create the article of footwear.

Example 37. The method of any example herein, particularly example 36, further comprising updating the model based on one or more received inputs of design elements selected by a user from the plurality of selectable design elements.

Example 38. The method of any example herein, particularly example 37, further comprising creating the article of footwear from the updated model.

Example 39. The method of any example herein, particularly any one of examples 34-38, wherein the two or more different articles of footwear can be formed from the base footwear structure, by one or more of modifying one or more design elements of and adding one or more design elements to the base footwear structure.

Example 40. The method of any example herein, particularly any one of examples 34-39, wherein the base footwear structure further comprises the sole structure.

In view of the many possible embodiments to which the principles of the disclosed technology may be applied, it should be recognized that the illustrated embodiments are only preferred examples of the disclosed technology and should not be taken as limiting the scope of the claimed subject matter. Rather, the scope of the claimed subject matter is defined by the following claims and their equivalents.

1. A non-transient computer-readable medium containing instructions for causing a computing system to perform the method of:
selecting a base footwear structure, the base footwear structure comprising an upper that is configured to be coupled to a sole structure;
retrieving a model of an article of footwear to be formed from the selected base footwear structure, wherein the model is stored in the computer-readable medium;
selecting one or more design elements from a plurality of available design elements associated with the model, wherein the one or more design elements are design elements to be added to or modified on the base footwear structure to form the article of footwear;
updating the model based on the one or more selected design elements; and
generating the article of footwear from the updated model,
wherein the upper comprises a base material, an internal support structure comprising one or more reinforcement elements or linings, a closure element arranged at a heel portion of the upper, and a lacing region, and wherein the one or more selected design elements includes a selection of one or more structures that define the one or more reinforcement elements or linings, the closure element, and the lacing region.

2. The non-transient computer-readable medium of claim 1, wherein the base footwear structure further comprises the sole structure, the sole structure coupled to the upper.

3. The non-transient computer-readable medium of claim 2, wherein the sole structure comprises a midsole and an outsole and wherein the one or more selected design elements includes a cushioning element for the midsole.

4. The non-transient computer-readable medium of claim 1, wherein selecting the one or more design elements includes selecting a footwear design model from a plurality of available footwear design models stored in the model, wherein each footwear design model includes a combination of predetermined design elements to be updated on or added to the base footwear structure.

5. The non-transient computer-readable medium of claim 1, wherein selecting the one or more design elements includes individually selecting one or more design elements from one or more lists of design elements stored in the model.

6. The non-transient computer-readable medium of claim 1, wherein the one or more selected design elements include one or more of a color of the upper, a material of the upper, a color of the sole structure, a style of the sole structure, and an overlay for the upper.

7. The non-transient computer-readable medium of claim 6, wherein the one or more selected design elements includes the overlay for the upper and wherein the selecting the one or more design elements further comprises selecting one or more of a color, material, shape, and size of the selected overlay from a list of available options stored in the model.

8. The non-transient computer-readable medium of claim 1, wherein the one or more selected design elements includes a sole structure having a predetermined style, the predetermined style of the selected sole structure including one or more of a shape, size, and patterning of the sole structure.

9. The non-transient computer-readable medium of claim 1, wherein selecting the base footwear structure includes selecting one base footwear structure from a finite number of distinct base footwear structures, wherein each of the distinct base footwear structures includes an upper configured to be coupled to a sole structure, and wherein each of the distinct base footwear structures has a differently structured upper from each of the other distinct base footwear structures in the finite number of distinct base footwear structures.

10. The non-transient computer-readable medium of claim 1, wherein selecting the base footwear structure includes selecting one base footwear structure from a finite number of distinct base footwear structures, wherein each of the distinct base footwear structures includes an upper and a sole structure coupled to the upper, and wherein each of the distinct base footwear structures has a sole structure that is distinct from each of the other distinct base footwear structures.

11. A non-transient computer-readable medium containing instructions for causing a computing system to perform the method of:
selecting a base footwear structure, the base footwear structure comprising a sole structure and an upper, the upper coupled to the sole structure;
retrieving a model of an article of footwear to be formed from the selected base footwear structure;
selecting one or more modifiable design elements from a first list of available modifiable design elements stored in the model, wherein the one or more modifiable design elements are design elements to be updated on the base footwear structure to form the article of footwear, wherein the upper comprises an internal support structure comprising one or more reinforcement elements or linings, and wherein the one or more selected modifiable design elements includes a selection of one or more structures that define the one or more reinforcement elements or linings;
selecting one or more add-on design elements from a second list of available add-on design elements stored in the model, wherein the one or more add-on design elements are design elements to be added to the base footwear structure to form the article of footwear;
updating the model based on the one or more selected modifiable design elements and the one or more selected add-on design elements; and
generating the article of footwear from the updated model.

12. The non-transient computer-readable medium of claim 11, wherein selecting the base footwear structure includes selecting one base footwear structure from a finite list of multiple, distinct base footwear structures.

13. The non-transient computer-readable medium of claim 11, wherein the one or more selected modifiable design elements include one or more of a color of the upper, a material of the upper, a color of the sole structure, a material of the sole structure, and a patterning of one or more components of the sole structure.

14. The non-transient computer-readable medium of claim 11, wherein the one or more selected add-on design elements include an overlay for the upper and further comprising selecting a design of the selected overlay, the design including one or more of a color, material, and graphic for the overlay.

15. The non-transient computer-readable medium of claim 11, wherein the one or more selected add-on design elements include one or more of a style of the sole structure, the style including one or more of a shape, size, patterning, and color of the sole structure, a graphic that is added to the upper, and a stitching detail that is added to the upper.

16. The non-transient computer-readable medium of claim 11, wherein updating the model based on the one or more selected modifiable design elements and the one or more selected add-on design elements includes updating base design elements of the base footwear structure to have the selected modifiable design elements and adding the selected add-on design elements to the base footwear structure, within the model, and further comprising, storing the updates within the model.

17. A non-transient computer-readable medium containing instructions for causing a computing system to perform the method of:
obtaining a plurality of structural and design elements from two or more different articles of footwear that are visually distinct; and
determining the base footwear structure from the obtained plurality of structural and design elements, wherein the base footwear structure comprises an upper configured to be coupled to a sole structure and is generic to the two or more different articles of footwear.

18. The non-transient computer-readable medium of claim 17, wherein determining the base footwear structure includes determining structural and design elements out of the obtained plurality of structural and design elements that are common to the two or more different article of footwear and constructing the base footwear structure from the determined common structural and design elements.

19. The non-transient computer-readable medium of claim 17, wherein the non-transient computer-readable medium contains instructions for causing the computing system to perform the method of creating a model of an article of footwear that can be formed from the base footwear structure, the model including the base footwear structure and a plurality of selectable design elements that can be selected by a user and modified on or added to the base footwear structure to create the article of footwear.

20. The non-transient computer-readable medium of claim 19, wherein the non-transient computer-readable medium contains instructions for causing the computing system to perform the method of updating the model based on one or more received inputs of design elements selected by a user from the plurality of selectable design elements.
